(19) United States
(12) Patent Application Publication
(10) Pub. No.: US 2025/0276201 A1
(43) Pub. Date: Sep. 4, 2025

(54) SENSOR-ENABLED RESPIRATOR FIT-TEST SYSTEM WITH CONTEXT-BASED REMEDIAL RECOMMENDATIONS

(71) Applicant: 3M INNOVATIVE PROPERTIES COMPANY, St. Paul, MN (US)

(72) Inventors: Richard C. Webb, St. Paul, MN (US); Andrew S. Viner, St. Paul, MN (US)

(21) Appl. No.: 19/091,787

(22) Filed: Mar. 26, 2025

Related U.S. Application Data
(63) Continuation of application No. 17/310,866, filed on Aug. 27, 2021.
(60) Provisional application No. 62/812,106, filed on Feb. 28, 2019.

(51) Int. Cl. A62B 9/00; G09B 23/00

(52) U.S. Cl. CPC A62B 9/006; G09B 23/00

(57) ABSTRACT

A system for ensuring proper fit of a negative-pressure respirator is disclosed. The system includes a negative-pressure respirator that a user can wear, and a sensor positioned within the interior of the respirator. The sensor contains a sensing element capable of detecting fluid-soluble particulate matter and generating data based on shifts in an electrical property of the sensing element. This data is forwarded to a mobile computing device configured with one or more processors and associated memory. The mobile device, upon executing instructions stored in its memory, receives the particulate matter data from the sensor and analyzes whether the respirator meets a preset fit-test criterion. Based on that determination, the device presents at least one graphical element on its display, instructing the user to perform a specific action that facilitates or confirms proper fit of the respirator.

### TECHNICAL FIELD

The present disclosure relates to the field of personal protective equipment. More specifically, the present disclosure relates to personal protective equipment that may be communicatively coupled to other computing devices.

### BACKGROUND

When working in areas where there is known to be, or there is a potential of there being, dusts, fumes, gases, airborne contaminants, fall hazards, hearing hazards or any other hazards that are potentially hazardous or harmful to health, it is typical for a worker to use personal protective equipment (PPE). While a large variety of personal protective equipment are available, some commonly used devices include powered air purifying respirators (PAPR), self-contained breathing apparatuses, reusable respirators, disposable respirators, fall protection harnesses, ear muffs, face shields, and welding masks. In the case of respiratory PPE, a worker may be fit-tested with a respirator to determine whether the respirator sufficiently limits the worker's exposure to respiratory contaminants.

### BRIEF DESCRIPTION OF THE DRAWINGS

FIG. 1 illustrates an example respirator sensor system, in accordance with techniques of this disclosure.

FIG. 2 illustrates an example respirator sensor system with an interior view of a respirator, in accordance with techniques of this disclosure.

FIG. 3 illustrates an example system including a mobile computing device, a respirator with a sensor, an aerosol generator, and a personal protection equipment management system, in accordance with techniques of this disclosure.

FIGS. 4A and 4B illustrate a view of a graphical user interface implemented in accordance with techniques of this disclosure.

FIGS. 5A and 5B illustrate a view of a graphical user interface implemented in accordance with techniques of this disclosure.

FIGS. 6A and 6B illustrate a view of a graphical user interface implemented in accordance with techniques of this disclosure.

FIGS. 7A and 7B illustrate a view of a graphical user interface implemented in accordance with techniques of this disclosure.

FIGS. 8A and 8B illustrate a view of a graphical user interface implemented in accordance with techniques of this disclosure.

FIGS. 9A and 9B illustrate a view of a graphical user interface implemented in accordance with techniques of this disclosure.

FIGS. 10A and 10B illustrate a view of a graphical user interface implemented in accordance with techniques of this disclosure.

FIG. 11 is a block diagram illustrating an example computing system that includes a personal protection equipment management system (PPEMS) in accordance with techniques of this disclosure.

FIG. 12 is a block diagram illustrating an operating perspective of a PPEM, in accordance with techniques of this disclosure.

FIG. 13 is a flow diagram illustrating example operations of a wireless, respiratory fit-testing system, in accordance with one or more techniques of this disclosure.

FIG. 14 is a flow diagram illustrating example operations of a respiratory fit-testing system that provides remedial recommendations, in accordance with one or more techniques of this disclosure.

It is to be understood that the embodiments may be utilized and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

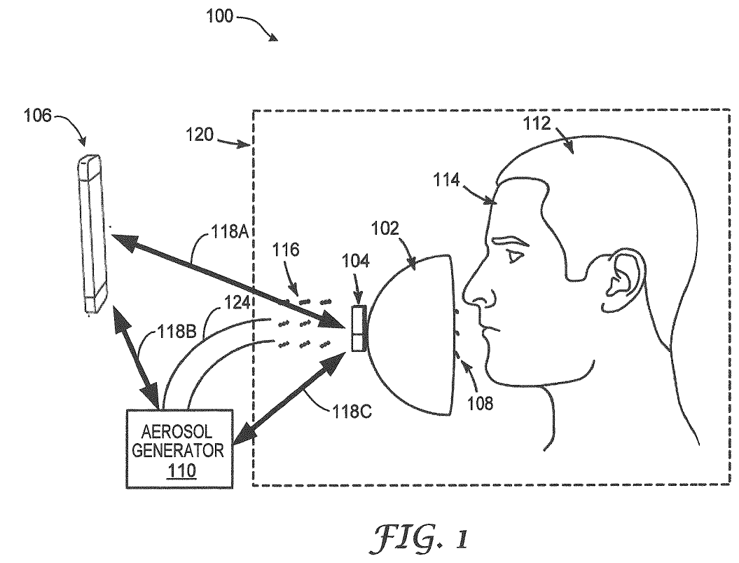

FIG. 1 illustrates respirator sensor system 100, in accordance with techniques of this disclosure. System 100 includes a respirator 102, a sensor 104 including a sensing element (as described herein), and a mobile computing device 106 configured to be in wireless communication with the sensor 104. Sensor 104 is positioned substantially within an interior gas space of the respirator or mounted substantially on the exterior surface of the respirator 102, as shown in FIG. 1. Respirator sensor system 100 may be configured to detect the presence of unfiltered air within the interior gas space 108 of the respirator 102. As described herein, a sensing element of sensor 104 is configured to sense fluid-soluble particulate matter when a liquid layer is disposed in a gap on at least a part of the surface of the sensing element. Fluid ionizable particles may at least partially dissolve and may at least partially ionize in the liquid layer, resulting in a change in an electrical property between at least two of the electrodes.

Water vapor may be produced by human breath inside of the respirator and condense onto a high surface energy region of the sensing element of sensor 104 and form the liquid layer. In an example, salt aerosol particles, such as sodium chloride, may come into contact with this condensed water vapor so that the salt particle dissolves and alters an electrical property (for example, impedance) of at least one of the electrode pairs of the sensing element of sensor 104. This change in electrical property may be sensed by the sensor 104 and wirelessly communicated to another computing device such as mobile computing device 106, a computing device configured within aerosol generator device 110, or a personal protective equipment management system (PPEMS) as further described in this disclosure. The transport of the fluid ionizable particulate matter to the sensing element of sensor 104 may occur by human breath. In some embodiments, the transport of the fluid ionizable particulate matter to the sensing element may be conducted by using a gas-moving element. In some embodiments, the gas-moving element is a fan or pump.

The sensing element of sensor 104 may be a fluid ionizable detection element that may be configured such that the condensing vapor does not condense uniformly on the surface of the sensing element, as described above. The fluid ionizable detection element may be further configured such that the condensed vapor in contact with at least one electrode does not form a continuous condensed phase to at least one other electrode.

Respirator 102 may be any personal protective respirator article such as a filtering facepiece respirator or elastomeric respirator, for example. Sensor 104 may include a power source, communication interface, sensing electronics, and antenna. Sensor 104 power source may be a battery, a rechargeable battery, or energy harvester.

The sensing element of sensor 104 may be configured to be replaceable and mechanically separable from the sensor 104. The sensing element may be communicatively coupled to the sensor 104. For instance, the sensing element of sensor 104 may be in wireless communication with sensor 104. Sensor 104 may be reusable by replacing a used or spent sensing element with an unused or new sensing element.

Sensor 104 may be fixed to, or adhered to, or connected to an interior surface of respirator 102 or personal protective device or element. The interior surface may define an interior gas space 108 of respirator 102 when worn by a user 112 to cover at least a portion of the user 112's face 114. Interior gas space 108 may be in airflow communication with the breath of the user wearing respirator 102 or personal protective device or element. In some embodiments, sensor 104 may be removably positioned or attached within the interior gas space. In some embodiments, sensor 104 may be removably positioned or attached to the interior surface of respirator 102. In some embodiments, sensor 104 may be removably positioned or attached to an exterior surface of respirator 102. Sensor 104 may be fixed to, or adhered to, or connected to an interior surface or an exterior surface of the respirator 102 by any attachment system, such as, adhesive, hook and loop, friction fit connector, or suction, for example. For example, sensor 104 may attach to an exterior surface of the respirator by way of a port (not shown) in the respirator which creates a fluid channel between the interior gas space of the respirator and the exterior gas space. For example, sensor 104 may be coupled to such a port by pressing sensor 104 to the port, i.e. a friction fit connection.

The size and weight of sensor 104 may be selected such that the sensor does not interfere with a wearer's use of respirator 102. The size of sensor 104 and a weight of sensor 104 are selected such that sensor 104 does not alter the fit of respirator 102 on a wearer. Sensor 104 may have a weight in a range from 0.1 to 225 grams, such as less than 10 grams, or from 1 to 10 grams. A sensor weighing 225 grams may not alter the fit of the respirator if the respirator is sufficiently tight, but lower weights may be used so as to reduce the weight of the respirator. Sensor 104 may have a volume in a range from 0.1 to 50 cm3, and may be less than 10 cm3, or from 1 to 10 cm3.

In some examples, aerosol generator device 110 may generate an aerosol 116 with a particulate concentration defined according to a particulate concentration parameter. Aerosol generator device 110 may provide aerosol 116 to enclosure 120 that is physically supported around the head of user 112. Aerosol generator device 110 may provide aerosol 116 to enclosure 120 via a conduit 124. Conduit 124 may be a hose, port, or other suitable device for fluidly transporting aerosol 116 to enclosure 120. Aerosol generator device 110 delivers aerosol 116 according to a known aerosol parameter to a region that is at least partially contained within the enclosure 120 around the head of user 112, where enclosure 120 at least partially contains the aerosol 116 around the head of user 112. In some examples, enclosure 120 may be a hood that covers the head of user 112. The term “supported around the head of user 112” may mean that enclosure 120 is supported by the user's head and/or shoulders, such as, for example, by supports that allow the enclosure to be operably connected to the user's head and/or shoulders.

Mobile computing device 106 may be a smartphone, wearable computing device, tablet, smart eyewear. In other examples, mobile computing device 106 may be a desktop computer, server, or any other computing device. Aerosol generator device 110 may include a computing device to perform one or more operations such as, but not limited to: starting and stopping the delivery of aerosol 116 to enclosure 120; changing the particulate concentration within aerosol 116; and/or communicating data with sensor 104, mobile computing device 106, and/or a PPEMS. Each of mobile computing device 106, aerosol generator device 110, and sensor 104 may include a communication device. Aerosol generator device 110 may include an assembly of components. The assembly may contain a communication device which controls the one or more operations of the aerosol generator device 110. In some examples, a communication device in a physical assembly may control the transmission of power to the aerosol generator 110. Each communication device may enable the communication of data using one or more of communication links 118A-118C. Communication links 118A-118C may be wired or wireless communication links. Examples of such communication links may include USB, Bluetooth, 802.11 wireless networks, 802.15 ZigBee networks, and any other suitable communication technology.

Some conventional fit-testing systems can be expensive and/or relatively non-portable. For example, particle counting respirator fit testing systems may require relatively large and/or expensive equipment such as laser optics, large pumps, and vapor condensation systems. As another example, fit test systems that use suction pressure on the respirator require large adapters and heavy, expensive air pumps. As such, the cost of these systems may be prohibitive for users or limit the number of systems that may be available to such users. Additionally, such systems may be difficult to transport and may be prone to theft in a work environment.

Rather than using expensive, and/or non-portable systems, techniques and systems of this disclosure may perform fit-testing using a sensor operatively coupled to the respirator, such as sensor 104 in FIG. 1, which may wirelessly communicate with mobile computing device 106. For instance, system 100 may guide a user through a respirator fit-test using a step-by-step graphical user interface without the requirement of counting particles. System 100 may therefore perform fit tests at a lower cost than conventional systems. Furthermore, as described in this disclosure, system 100 may output one or more recommendations if a failure in the fit-test has occurred, thereby simplifying the procedure by which the user selects and/or uses a respirator in a way that will provide sufficient respiratory protection for the user and ultimately improve user safety.

Sensor 104 may include an electric circuit configured to determine a change in at least one electrical characteristic of a sensing element. In some examples, the change in the at least one electrical characteristic is based at least in part on detection of particulate matter. Sensor 104 may include a communication component configured to communicate data that is based at least in part on the change in the at least one electrical characteristic of the sensing element. Techniques and systems for implementing sensor 104 and detection of the change in the at least one electrical characteristic are described in the following patent applications, each of which is incorporated by reference herein in its entirety: IB2018/056557 (filed Aug. 28, 2018); IB2018/056559 (filed Aug. 28, 2018); IB2018/056560 (filed Aug. 28, 2018); US2018/049052 (filed Aug. 31, 2018); US2018/049031 (filed Aug. 31, 2018); US2018/049079 (filed Aug. 31, 2018); US2018/049082 (filed Aug. 31, 2018).

Sensor 104 may communicate wirelessly with mobile computing device 106. In some examples, mobile computing device 106 may output for display, based at least in part on a determination that particulate matter has been provided in proximity to the respirator, at least one graphical element in a set of graphical elements. In some examples, in proximity to the respirator may mean: in contact with the respirator; within one inch of the respirator; or within a distance from the respirator that, if the user inhaled air, would draw air against the respirator's outer surface (i.e., the surface not facing the user's mouth). Each graphical element in the set of graphical elements may correspond to an action to be performed by the user in a fit test. Graphical elements may be any visual indication output for display by mobile computing device 106. Examples of graphical elements include but are not limited to: text, images, moving images, buttons, lists, tables, views, check boxes, radio buttons and any other suitable user interface element. One or more graphical elements may be included in a graphical user interface as further illustrated in various examples of this disclosure.

In some examples, mobile computing device 106 may receive data that is based at least in part on a change in at least one electrical characteristic of the sensing element in sensor 104. For instance, based on the presence of particulate matter generated by an aerosol generator device 110 and present at the sensing element, a change in an electrical characteristic (e.g., impedance) may be determined by sensor 104 and sent as data to mobile computing device 106. Mobile computing device 106 may determine, during at least one action that corresponds to the at least one graphical element and is performed by the user, whether the fit test was satisfied. In some examples, system 100 may determine whether the fit test was satisfied without counting particles. In some examples, the counted particles may be of a particular type of particulate matter. In some examples, whether the fit test was satisfied may be based at least in part on a fractional leakage of particles between a perimeter of the respirator and the user's face. In some examples, whether the fit test was satisfied may be based at least in part on whether that leakage is below a fit test requirement.

In accordance with techniques of this disclosure, a fit test may be divided into multiple stages. Each stage may include one or more respective actions to be performed by the user. A stage may have a particular time duration that is user- and/or machine-configured. If a change in an electrical characteristic is detected, sensor 104 and/or mobile computing device 106 may determine that a leak occurred and/or that the fit test was not satisfied at a particular stage. In some examples, sensor 104 and/or mobile computing device 106 may determine that a leak occurred and/or that the fit test was not satisfied at a particular stage if the change in the electrical characteristic satisfies a threshold. In some examples, the change satisfies a threshold if the change is greater than or equal to the threshold. In other examples, the change satisfies a threshold if the change is less than or equal to the threshold.

In some examples, mobile computing device 106 may, while performing the fit test, output a set of graphical user interfaces that guide the user through each stage of the fit test. Such examples are further illustrated in this disclosure. If a user completes a stage of the fit test, and sensor 104 and/or mobile computing device 106 does not detect a leak that would cause the fit test to not be satisfied, mobile computing device 106 may output for display one or more other graphical elements or graphical user interfaces that correspond to other stages of the fit test. Accordingly, in response to the determination whether the fit test was satisfied, mobile computing device 106 may perform at least one operation that is based at least in part on the determination whether the fit test was satisfied. If, however, mobile computing device 106 determines that the fit test was not satisfied for a particular stage, then mobile computing device 106 may output for display an indication that the fit test has failed. In some examples, mobile computing device 106 may perform one or more other operations described in this disclosure. In some examples, mobile computing device 106 may determine, based at least in part on particular context data associated with the fit test, at least one remedial recommendation to satisfy the fit test. Mobile computing device 106 may output for display the at least one remedial recommendation to satisfy the fit test.

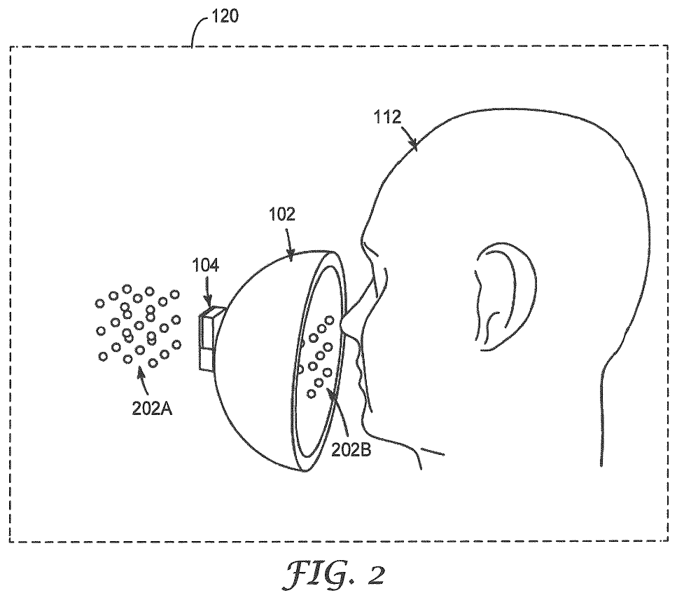

FIG. 2 illustrates respirator sensor system 100 with an interior view of respirator 102, in accordance with techniques of this disclosure. In some examples, respirator 102 is donned by user 112. Aerosol generator device 110 may provide aerosol with particulates according to an aerosol output parameter. Particulates 202A that are external to respirator 102 may be at a higher concentration than particulates 202B that are within the cavity of respirator 102. In some examples, enclosure 120, such as a hood, is physically supported around the head of user 112. Aerosol generator device 110 may deliver aerosol with particulates 202A-202B, according to a known aerosol parameter, that is at least partially contained within the enclosure around the user's head, and the enclosure may at least partially contain aerosol around the wearer's head. Sensor 104 may include a sensing element operably connected to the respirator 102, wherein sensor 104 is configured to monitor a particulate concentration of particulates 220B within respirator 102. In some examples, a mobile computing device (not shown) may be configured to communicate with the sensor 104. As described in this disclosure, the mobile computing device may be configured to compare, determine a relationship, or otherwise process data that is based on a particulate concentration of particulates 202A within the cavity of respirator 102 and a particulate concentration of particulates 202B outside the cavity of respirator 102. Sensor 104 may wirelessly communicate with one or more other computing devices to perform a fit test in accordance with techniques of this disclosure.

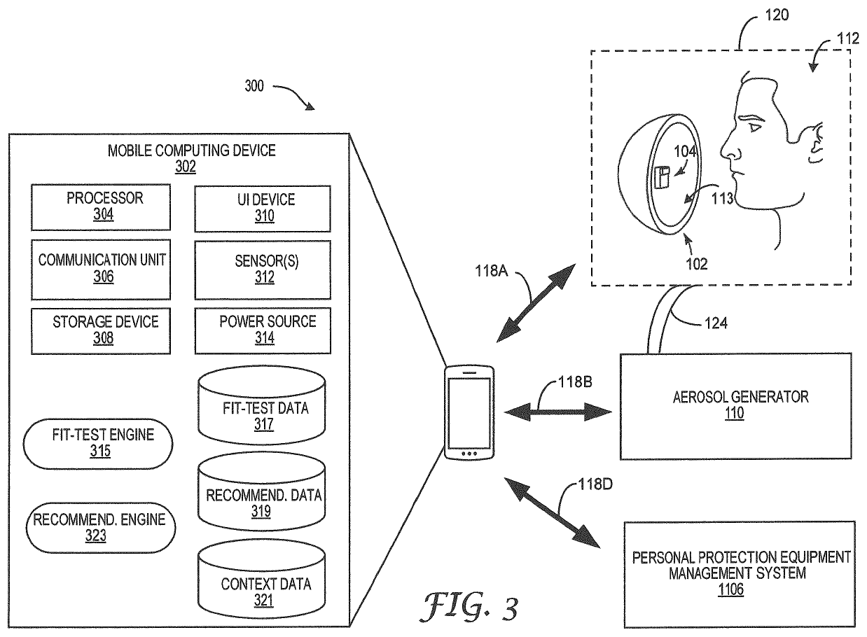

FIG. 3 illustrates an example system including a mobile computing device, a respirator with a sensor, an aerosol generator, and a personal protection equipment management system, in accordance with techniques of this disclosure. For purposes of illustration only, system 300 includes mobile computing device 302, which may be an example of mobile computing device 106 in FIG. 1.

Mobile computing device 302 may include processor 304, communication unit 306, storage device 308, user-interface (UI) device 310, power source 314, and sensors 312. As noted above, mobile computing device 302 represents one example of mobile computing device 106 shown in FIG. 1, and many other examples of mobile computing device 302 may be used in other instances. In some examples, mobile computing device 106 may include a subset of the components included in mobile computing device 302 or may include additional components not shown example mobile computing device 302.

In some examples, mobile computing device 302 may be an intrinsically safe computing device, smartphone, wrist- or head-wearable computing device, or any other computing device that may include a set, subset, or superset of functionality or components as shown in mobile computing device 302. Communication channels may interconnect each of the components in mobile computing device 302 for inter-component communications (physically, communicatively, and/or operatively). In some examples, communication channels may include a hardware bus, a network connection, one or more inter-process communication data structures, or any other components for communicating data between hardware and/or software.

Mobile computing device 302 may also include power source 314, such as a battery, to provide power to components shown in mobile computing device 302. A rechargeable battery, such as a Lithium Ion battery, may provide a compact and long-life source of power. Mobile computing device 302 may be adapted to have electrical contacts exposed or accessible from the exterior of the housing of mobile computing device 302 to allow recharging of power source 314. As noted above, mobile computing device 302 may be portable such that it can be carried or worn by a user. Mobile computing device 302 can also be personal, such that it is used by an individual and communicates with personal protective equipment (PPE) assigned to that individual. In FIG. 3, mobile computing device 302 may be secured to a user by a strap. However, mobile computing device 302 may be carried by a user or secured to a user in other ways, such as being secured to PPE being worn by the user, to other garments being worn to a user, being attached to a belt, band, buckle, clip or other attachment mechanism as will be apparent to one of skill in the art upon reading the present disclosure.

One or more processors 304 may implement functionality and/or execute instructions within mobile computing device 302. For example, processor 304 may receive and execute instructions stored by storage device 308. These instructions executed by processor 304 may cause mobile computing device 302 to store and/or modify information, within storage devices 308 during program execution. Processors 304 may execute instructions of components illustrated in mobile computing device 302 to perform one or more operations in accordance with techniques of this disclosure. That is, one or more of the components illustrated within mobile computing device 302 may be operable by processor 304 to perform various functions described herein.

One or more communication units 306 of mobile computing device 302 may communicate with external devices by transmitting and/or receiving data. For example, mobile computing device 302 may use communication units 306 to transmit and/or receive radio signals on a radio network such as a cellular radio network. In some examples, communication units 306 may transmit and/or receive satellite signals on a satellite network such as a Global Positioning System (GPS) network. Examples of communication units 306 include a network interface card (e.g. such as an Ethernet card), an optical transceiver, a radio frequency transceiver, a GPS receiver, or any other type of device that can send and/or receive information. Other examples of communication units 306 may include Bluetooth®, GPS, 3G, 4G, and Wi-Fi® radios found in mobile devices as well as Universal Serial Bus (USB) controllers and the like.

One or more storage devices 308 within mobile computing device 302 may store information for processing during operation of mobile computing device 302. In some examples, storage device 308 is a temporary memory, meaning that a primary purpose of storage device 308 is not long-term storage. Storage device 308 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage device 308 may, in some examples, also include one or more computer-readable storage media. Storage device 308 may be configured to store larger amounts of information than volatile memory. Storage device 308 may further be configured for long-term storage of information as non-volatile memory space and retain information after activate/off cycles. Examples of non-volatile memories include magnetic hard discs, optical discs, floppy discs, flash memories, or forms of electrically programmable memories (EPROM) or electrically erasable and programmable (EEPROM) memories. Storage device 308 may store program instructions and/or data associated with components such as rule engine 318 and alert engine 322.

UI device 310 may be configured to receive user input and/or output information to a user. One or more input components of UI device 310 may receive input. Examples of input are tactile, audio, kinetic, and optical input, to name only a few examples. UI device 310 of mobile computing device 302, in one example, include a mouse, keyboard, voice responsive system, video camera, buttons, control pad, microphone or any other type of device for detecting input from a human or machine. In some examples, UI device 310 may be a presence-sensitive input component, which may include a presence-sensitive screen, touch-sensitive screen, etc.

One or more output components of UI device 310 may generate output. Examples of output are data, tactile, audio, and video output. Output components of UI device 310, in some examples, include a presence-sensitive screen, sound card, video graphics adapter card, speaker, cathode ray tube (CRT) monitor, liquid crystal display (LCD), or any other type of device for generating output to a human or machine. Output components may include display components such as cathode ray tube (CRT) monitor, liquid crystal display (LCD), Light-Emitting Diode (LED) or any other type of device for generating tactile, audio, and/or visual output. Output components may be integrated with mobile computing device 302 in some examples.

UI device 310 may include a display, lights, buttons, keys (such as arrow or other indicator keys) and may be able to provide alerts to the user in a variety of ways, such as by sounding an alarm or vibrating. UI device 310 can be used for a variety of functions. For example, a user may be able to receive alerts through the user interface and/or display information. The user interface may also be used to control settings of, display information of, or otherwise interoperate with other devices such as sensor 104, aerosol generator 110, and/or PPEMS 1106.

Sensors 312 may include one or more sensors that generate data indicative of an activity of user 112 associated with mobile computing device 302 and/or data indicative of an environment in which mobile computing device 302 is located. Sensors 312 may include, as examples, one or more accelerometers, one or more sensors to detect conditions present in a particular environment (e.g., sensors for measuring temperature, humidity, particulate content, noise levels, air quality, or any variety of other characteristics of environments in which respirator 102 may be used), or a variety of other sensors.

System 300 of FIG. 3 may include respirator 102, sensor 104, user 112, and enclosure 120. In some examples, system 300 may include aerosol generator 110. System 300 may include PPEMS 1106 as further described in this disclosure. Each of mobile computing device 302, sensor 104, aerosol generator device 110, and/or PPEMS 1106 may be communicatively coupled to one another. For example, one or more of the aforementioned devices may be communicatively coupled by communication links 118, which may communicate data via wireless and/or wired communications.

Fit test engine 315 may be a combination of hardware and software that executes one or more techniques of this disclosure. For instance, fit-test engine 315 may cause UI device 310 to output for display, based at least in part on a determination that particulate matter has been provided in proximity to a respirator, at least one graphical element in a set of graphical elements. In some examples, the graphical elements may be stored in fit-test data 317 and selected by fit-test engine 315. In some examples, fit-test data 317 may include specifications or other data defining respective actions, stages, and fit-tests, in accordance with techniques of this disclosure. As further described in this disclosure, fit-test engine 315 may select specifications or other data from fit-test data 317 when outputting various GUIs for display and/or determining whether a fit-test has been satisfied.

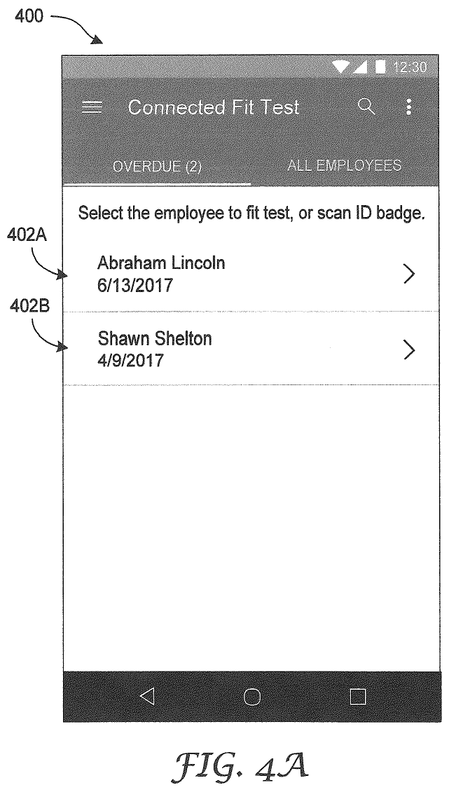

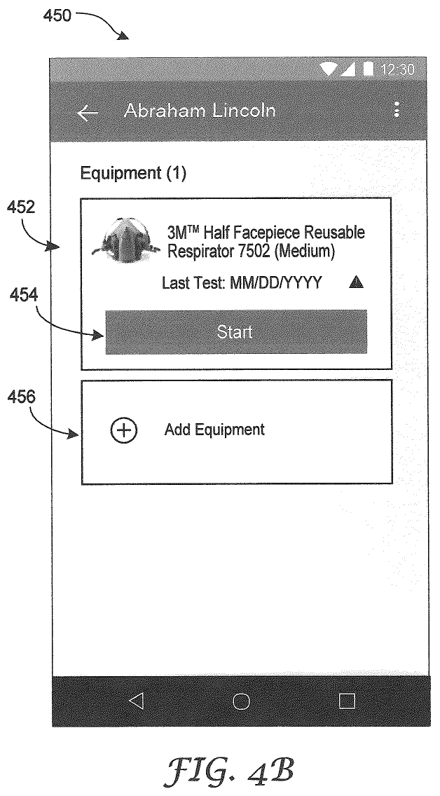

In some examples, each graphical element in the set of graphical elements corresponds to an action to be performed by a user in a fit test. Various actions are described in the examples of FIGS. 4-10. In some examples, respirator 102 may be worn by user 112 and sensor 104 may be operatively coupled to respirator 102. Sensor 104 may include an electric circuit configured to determine a change in at least one electrical characteristic of a sensing element. The change in the at least one electrical characteristic may be based at least in part on detection of particulate matter. In some examples, sensor 104 may include a communication component that is configured to communicate data that is based at least in part on the change in the at least one electrical characteristic of the sensing element.

In some examples, in response to receiving data that is based at least in part on the change in the at least one electrical characteristic of the sensing element, fit-test engine 315 may determine, during at least one action that corresponds to the at least one graphical element and is performed by the user, whether the fit test was satisfied. In some examples, the data that is based at least in part on the change in the at least one electrical characteristic of the sensing element may represent an impedance value, a discrete value that indicates whether a leak has occurred, an amount of a leak, or any other value that corresponds to a determination of a change in an electrical characteristic of the sensing element.

In some examples, fit-test engine 315 may determine whether the fit test was satisfied based at least in part on data received from sensor 104. For example, in response to receiving the data that is based at least in part on the change in the at least one electrical characteristic of the sensing element, fit-test engine 315 may determine, during at least one action that corresponds to the at least one graphical element and is performed by the user, whether the fit test was satisfied. In some examples, fit-test engine 315 may determine whether the fit-test was satisfied without counting particles of particulate matter.

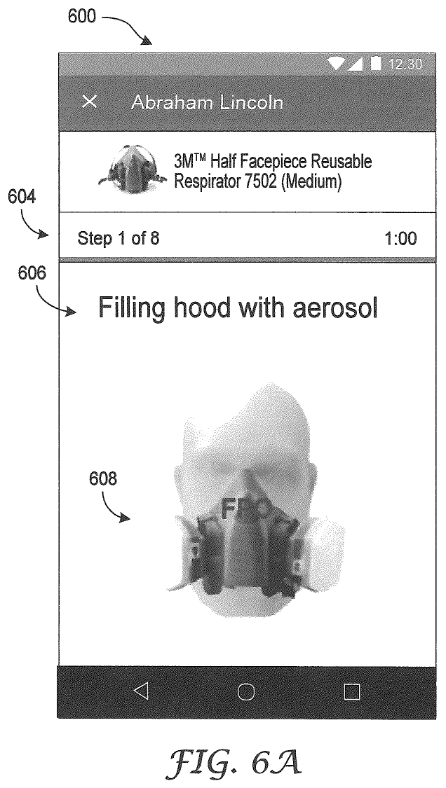

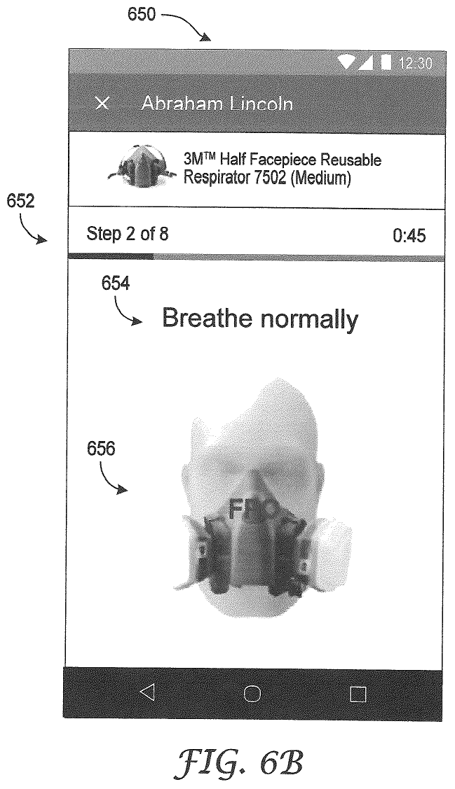

In some examples, fit-test engine 315 may output for display a first graphical user interface comprising the first graphical element that corresponds to the first action to be performed by the user in the fit test. For example, as shown in FIG. 6B, fit-test engine 315 may cause UI device 310 to output for display GUI 650 with one or more graphical elements. Fit-test engine 315 may determine, using first data that is based at least in part on at least one electrical characteristic of the sensing element, that a first stage of the fit test was satisfied for the first action performed by the user during a first defined time duration. For instance, the first stage may include “Breathe normally” as shown in GUI 650 of 6B.

Mobile computing device 302 may, in response to determining that the first stage of the fit test was satisfied for the first action performed by the user during the first defined time duration, output for display, without the first graphical user interface, a second graphical user interface comprising a second graphical element that corresponds to a second action to be performed by the user in the fit test. For example, mobile computing device 302 may determine that the “Breathe Normally” stage was satisfied because no leak was detected that exposed the user to an amount of particulate matter in the aerosol that satisfies a threshold. Mobile computing device 302 may cause GUI 700 to be output for display with another stage “Take deep breaths”. In some examples, GUI 700 may include graphical elements that correspond to the action or actions for the current stage. In this way, as each stage is satisfied in the fit test, different graphical elements and/or GUIs are output for display to guide the user through the fit-test. In some examples, mobile computing device 302 may generate audible and/or haptic alerts corresponding to an amount of time remaining in a stage. For example, mobile computing device 302 may provide an alert to the user that there are five seconds remaining in a current stage, before the next stage begins. In this way, the user receives additional reminders to change their actions.

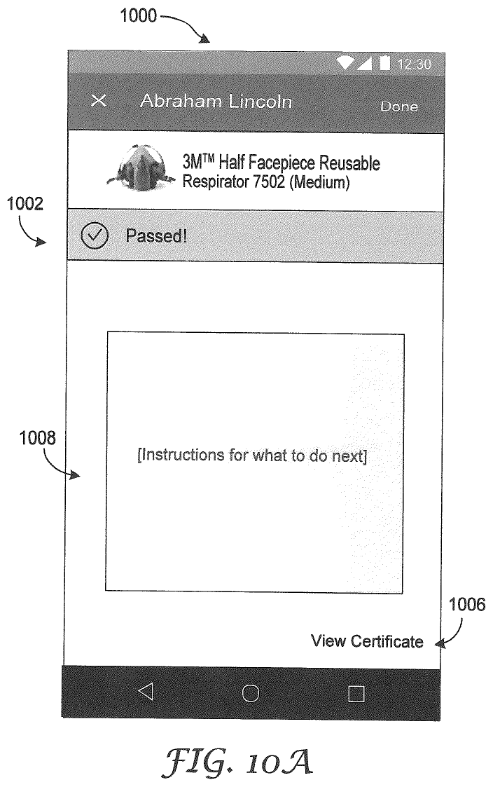

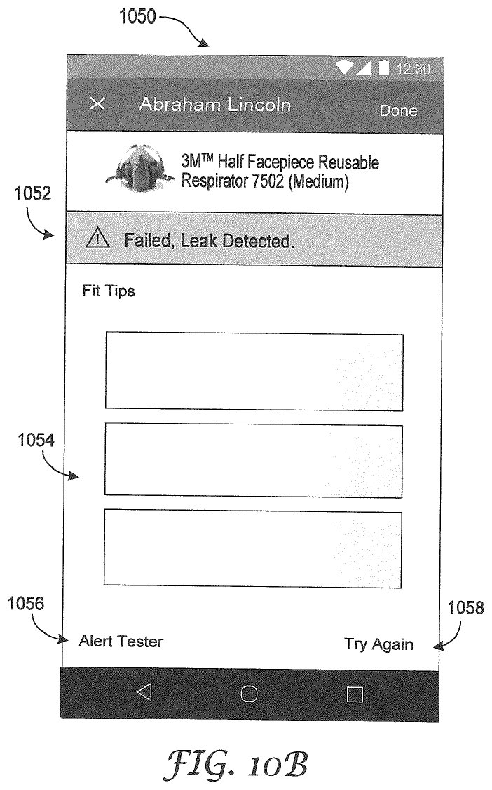

In some examples, mobile computing device 302 may determine, using data that is based at least in part on the change in the at least one electrical characteristic of the sensing element, that a particular stage of the fit test was not satisfied for the action performed by the user during a defined time duration. In response to determining that the particular stage of the fit test was not satisfied for the action performed by the user during the defined time duration, fit-test engine 315 may cause UI device 310 to output for display, a graphical element that indicates the fit test was not satisfied. For instance, as shown in FIG. 10B, GUI 1050 may output for display a graphical element 1052 that indicates the fit-test was not satisfied.

In some examples, mobile computing device 302 may determine, using data that is based at least in part on the change in the at least one electrical characteristic of the sensing element, that a particular stage of the fit test was satisfied for an action performed by the user during a defined time duration. In response to determining that the particular stage of the fit test was satisfied for the action performed by the user during the defined time duration, fit-test engine 315 may cause UI device 310 to output for display, a graphical element that indicates the fit test was satisfied. For instance, as shown in FIG. 10A, GUI 1000 may output for display a graphical element 1002 that indicates the fit-test was not satisfied.

In some examples, a graphical element may include at least one of an instruction to the user to perform an action, a physical depiction of the action, an elapsed amount of time in a defined time duration, a remaining amount of time in a defined time duration, or an indicator of the cardinality of a stage within a set of stages of a fit test. In some examples, the instruction to the user may be audible, visual, haptic, or in any other form that may be sensed by the user. Examples of such content in a graphical element are shown and described in FIGS. 4-10. In some examples, the action is at least one of a type of breathing, a motion of the head of the user, a motion of the torso of the user, or speaking by the user.

In some examples, fit-test engine 315 may determine that the particulate matter has been provided in proximity to the respirator by communicating with at least one of sensor 104 or aerosol generator device 110 and determining, based on the communication, that an aerosol comprising the particulate matter has been provided in proximity to respirator 102. In some examples, fit-test engine 315 may cause mobile computing device 302 to send a first message to aerosol generator device 110 that causes aerosol generator device 110 to start generation of an aerosol comprising the particulate matter that is provided in proximity to the respirator. Fit-test engine 315 may cause mobile computing device 302 to send a second message to aerosol generator device 110 to stop generation of the aerosol comprising the particulate matter that is provided in proximity to the respirator 102. In some examples, fit-test engine 315 may receive the data that is based at least in part on the change in the at least one electrical characteristic of the sensing element from aerosol generator device 110 that generates the aerosol comprising the particulate matter that is provided in proximity to the respirator.

In some examples, fit-test engine 315 may perform at least one operation by sending a message to a remote computing device, such as PPEMS 1106, that indicates whether the fit test was satisfied. The message may include, but is not limited to: date of fit test, time of fit test, subject's (user's) name in fit test, operator's name in fit test, respirator model and/or size in fit test, test protocol in fit test, whether the fit test passed or failed. PPEMS 1106 may perform one or more operations based at least in part on data in the message. Further examples of such data may include user identifier, timestamp of fit-test, location of fit-test, administrator of fit test, respirator model, respirator size, user face size, user breathing characteristic, activity of the user during the fit test, magnitude or presence of the change in the at least one electrical characteristic of the sensing element, elapsed time within a particular stage of a set of stages that comprise the fit test, elapsed time within the particular stage when the fit was determined to be not satisfied, remaining time within the particular stage of the set of stages that comprise the fit test, a failed fit test that occurred prior the fit test, an identifier for the particular stage of the fit test that was not satisfied, an amount of the particulate matter detected that is based at least in part on the change in the at least one electrical characteristic of the sensing element, or a demographic property of the user. PPEMS 1106 may perform one or more operations on the data, such as identifying trends, anomalies, or other statistical values based on the data. Further operations of PPEMS 1106 are described in this disclosure.

In some examples, a stage or action of a stage may be based at least in part on a safety regulation. A safety regulation may specify an action to be performed by the user to detect whether the fit-test has been satisfied. The action may be motion or activity that would allow a leak to be detected by system 300 between user 112's face and respirator 102. In some examples, fit-test engine 315 may receive data from another sensor that indicates motion of at least a part of user 112. In some examples, the sensor that indicates motion may be included within sensor 104 or included in another device other than sensor 104, such as in a device on the body or in the possession of user 112. In other examples, the device may be separate from sensor 104 and user 112. In some examples, fit-test engine 315 may determine whether the fit test was satisfied based at least in part on the sensor that indicates motion of at least a part of the user. For instance, fit-test engine 315 may determine that user 112 is not performing the action required during a particular stage. Accordingly, fit-test engine 315 may determine that the fit-test was not satisfied because the required action was not performed or was not sufficiently performed by user 112.

In some examples, fit-test engine 315 may receive data from another sensor that indicates air pressure within a cavity 113 of respirator 102 that covers at least a portion of a face of the user. Fit-test engine 315 may determine whether the fit test was satisfied based at least in part on the sensor that indicates air pressure within the cavity of the respirator that covers at least the portion of a face of user 112. In some examples, at least two graphical elements are contemporaneously output for display in a single graphical user interface by UI device 310. In some examples, the particulate matter is at least partially comprised of a salt. In some examples, the salt is sodium chloride. In some examples, the respirator is at least one of a disposable respirator, a negative-pressure reusable respirator, a powered-air purifying respirator, or a self-contained breathing apparatus respirator. In some examples, mobile computing device 302 is not fluidly coupled to respirator 102 by a hose or other physical coupling.

In some examples, fit-test engine 315 may determine whether sensor 104 was operating properly during the fit-test. For instance, fit-test engine 315 may determine that each stage of the fit test corresponding to a respective action was satisfied. Fit-test engine 315 may determine that the respirator 102 is at least partially removed from being worn by the user. Mobile computing device 106 may determine that a change in the at least one electrical characteristic sufficient to satisfy a threshold was not detected by sensor 104 and/or fit-test engine 315. Mobile computing device 302 may determine, based at least in part on the determination that the change in the at least one electrical characteristic sufficient to satisfy the threshold was not detected, that the fit test was not satisfied.

As shown in FIG. 3, mobile computing device 302 may include recommendation engine 323, which may be a combination of hardware and software that executes one or more techniques of this disclosure. In some examples, mobile computing device 302 may receive data that is based at least in part on a change in a at least one electrical characteristic of a sensing element included in sensor 104 that is operatively coupled to respirator 102. In response to receiving the data, recommendation engine 323 may determine, during at least one action that is performed by user 112 and that corresponds to the at least one graphical element, that a fit test was not satisfied.

Recommendation engine 323 may determine, based at least in part on particular context data 321 associated with the fit test, at least one remedial recommendation to satisfy the fit test. In some examples, context data may be any data that is descriptive of or characterizes any aspect of a fit test. Examples of context data include but are not limited to: data that indicates at least one of a respirator model, respirator size, user face size, user breathing characteristic, activity of the user during the fit test, magnitude or presence of the change in the at least one electrical characteristic of the sensing element, elapsed time within a particular stage of a set of stages that comprise the fit test, elapsed time within the particular stage when the fit was determined to be not satisfied, remaining time within the particular stage of the set of stages that comprise the fit test, a failed fit test that occurred prior the fit test, an identifier for the particular stage of the fit test that was not satisfied, an amount of the particulate matter detected that is based at least in part on the change in the at least one electrical characteristic of the sensing element, or a demographic property of the user. In some examples, recommendation engine 323 may receive an image of the respirator positioned at the user. Recommendation engine 323 may process the image as the particular context data in the determination of the at least one remedial recommendation. In some examples, recommendation engine 323 may process the image in accordance with systems and techniques described in patent application IB2018/056557 (filed Aug. 28, 2018), the entire content of which is hereby incorporated by reference in its entirety. Context data 321 may be generated, communicated, and/or processed by any of mobile computing device 302, sensor 104, aerosol generator device 110, and/or PPEMS 1106 to perform one or more techniques of this disclosure.

Recommendation engine 323 may use context data 321 to determine one or more remedial recommendations defined and/or stored in recommendation data 319. A remedial recommendation may be information that, if used by a user, may increase a likelihood that a fit-test will be satisfied. For instance, a remedial recommendation may be information that increases a likelihood that a fit-test will be satisfied following a failed fit-test. In some examples, one or more remedial recommendations may be more or less likely to result in a subsequent fit-test that is satisfied based on context data determined in a prior fit test. By using context data to select remedial recommendations, recommendation engine 323 may increase the likelihood that a user will satisfy a fit test. In some examples, recommendation engine 323 may cause UI device 310 to output for display at least one remedial recommendation to satisfy the fit test. Accordingly, a user may use or otherwise act with respect to the one or more remedial recommendations that are provided by recommendation engine 323.

In some examples, recommendation engine 323 may process context data 321 in the determination of the at least one remedial recommendation. For example, recommendation engine 323 may apply, based at least in part on a determination by fit-test engine 315 that a fit test was not satisfied, the particular context data to a recommendation model stored and/or configured in recommendation data 319. In some examples, the recommendation model may be implemented using one or more learning, statistical, or other suitable techniques. Example learning techniques that may be employed to generate and/or configure models can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

In some examples, the recommendation model may be modified, prior to a particular fit test and based on a set of training instances, to change a likelihood provided by the model for at least one remedial recommendation in response to subsequent context data applied to the recommendation model. Each training instance in the set of training instances may include an association between training context data and remedial recommendation. Recommendation engine 323 may select the at least one remedial action based at least in part on the likelihood provided by the model for the at least one remedial recommendation. Recommendation engine 323 may select at least one remedial action based at least in part on the likelihood provided by the model for the at least one remedial recommendation. Accordingly, in some examples, a recommendation model used by recommendation engine 323 may be based on context data associated with prior fit tests that were either satisfied or not satisfied. In some examples, remedial recommendations may be associated with the context data, such that given a particular set of context data, recommendation engine 323 may select one or more remedial recommendations that are more likely to result in a fit test that is satisfied. In this way, given a certain set of context data for a particular fit test, the recommendation model may determine remedial recommendations that assist the user to satisfy a subsequent fit test.

In some examples, recommendation engine 323 may select at least one remedial action that has a highest likelihood in a set of likelihoods that correspond respectively to a set of remedial recommendations. In some examples, the recommendation model is based at least in part on one or more prior fit tests performed using respirators that have similar characteristics to the respirator. In some examples, a first characteristic is similar to a second characteristic if the first characteristic is the same as the second characteristic. In some examples, a first characteristic is similar to a second characteristic if the first characteristic is equivalent to but not the same as the second characteristic. In some examples, a first characteristic is similar to a second characteristic if a degree of similarity between the first characteristic and the second characteristic is greater than or equal to 75%. In some examples, a first characteristic is similar to a second characteristic if a degree of similarity between the first characteristic and the second characteristic is greater than or equal to 90%.

In some examples, recommendation engine 323 may be implemented in a decision tree or a lookup data structure. For instance, recommendation engine 323 may configure a set of associations between remedial recommendations and failure mode context data. Failure mode context data may refer to context data where a fit test was not satisfied. Recommendation engine 323 may determine that particular context data corresponds to the failure mode context data. Recommendation engine 323 may select, based at least in part on the determination that the particular context data corresponds to the failure mode context data, the remedial recommendation from the set of remedial recommendations. In some examples, recommendation engine 323 may, to determine that particular context data corresponds to failure mode context data, determine a degree of similarity between the particular context data corresponds to the failure mode context data. In some examples, a remedial recommendation is selected by recommendation engine 323 from the set of remedial recommendations based on a defined order. In some examples, the defined order prioritizes remedial recommendations that change respirator fit ahead of remedial recommendations that change respirator size. In some examples, the defined order prioritizes remedial recommendations that change respirator size ahead of remedial recommendations that change respirator model.

In some examples, the remedial recommendation indicates at least an inspection or modification to a nose clip of a disposable respirator. In some examples, the remedial recommendation indicates at least an inspection or modification to a strap of a respirator. In some examples, the remedial recommendation indicates at least an inspection or modification to a filter or cartridge of a reusable respirator. In some examples, the remedial recommendation indicates at least an inspection of the exhalation or inhalation valves. In some examples, a remedial recommendation confirms that the user has less than 24 hours' growth of facial hair in respirator sealing areas, which may comprise regions of a user's face where a seal is formed between the respirator and the user's face. In some examples, a remedial recommendation may confirm that a user has conducted user seal checks at the interface between the respirator and the user's face. In some examples, mobile computing device 302 may output instructional materials, including videos, images, or audio content.

In some examples, for disposable respirators, the remedial recommendation may confirm if the user formed the noseclip. In some examples, if the metal is straight or not fully conformed to nose bridge, the remedial recommendation may ask the user to push firmly until the noseclip is fully conformed to the shape of the nose bridge. In some examples, the remedial recommendation may confirm if there is a peak at or near the center of the nose clip. Mobile computing device 302 may output videos, images, or audio content describing a peak at or near the center of the noseclip. In some examples, the remedial recommendation may ask a user to don a new facepiece. In some examples, the remedial recommendation may confirm that the user forms the nose clip with both hands, so no peak forms in the center of the nose clip. In some examples, the remedial recommendation may recommend the upper headband be positioned by the user at the crown of the user's head.

In some examples, the remedial recommendation may recommend that the bottom headband be positioned behind user's neck. In some examples, a remedial recommendation may recommend that both headbands of a fit-test be used and/or that neither should be hanging unused near the neck or removed by the user. In some examples, the remedial recommendation may recommend that all panels should be unfolded (e.g., for flatfold respirators). In some examples, an image or video may indicate a model showing where panels could be hidden. In some examples, the remedial recommendation may recommend that a bottom panel be pulled back to user's neck (e.g., for flatfold respirators).

In some examples, a remedial recommendation for a reusable respirator may recommend that the user inspect the respirator to ensure that all valve membranes are present, intact, and seated correctly. In some examples the remedial recommendation may include a model-specific image guide of different respirator models. In some examples, the remedial recommendation may confirm that that the head cradle is correctly positioned. In some examples, the remedial recommendation may confirm that the respirator is optimally positioned on the face. In some examples, the remedial recommendation may recommend trying a different size of this model. In some examples, the remedial recommendation may include images guiding size selection based on footprint of respirator relative to face. In any of the examples, the remedial recommendation may include videos, images, or audio content.

Recommendation engine 323 may determine, based at least in part on context data, a second respirator associated with a likelihood score of passing the fit test. Recommendation engine 323 may determine that the first likelihood score satisfies a threshold, and output, based at least in part on the determination that the likelihood score satisfies the threshold, information that indicates the second respirator in the remedial recommendation. In this way, recommendation engine 323 may recommend different respirators if a fit test was not satisfied. In some examples, the threshold may be based at least in part on a likelihood score of passing the fit test that is associated with at least one other respirator.

Although various functionalities and techniques have been described with respect to specific devices for example purposes, in other examples, different devices described in this disclosure may be configured to perform various functionalities and techniques described in this disclosure.

FIG. 4A illustrates a graphical user interface (GUI) 400 that indicates a set of users that are available for a fit test, in accordance with techniques of this disclosure. Although FIGS. 4A-10B illustrate example arrangements of graphical elements, other arrangements of graphical elements are possible and within the spirit and scope of this disclosure. Although FIGS. 4A-10B illustrate example appearances of graphical elements, other appearances of graphical elements are possible and within the spirit and scope of this disclosure. For purposes of illustration only, graphical user interfaces of FIGS. 4A-10B may be output for display by mobile computing device 106. In some examples, a graphical element may include more content than described in an example. In other examples, a graphical element may include less content than described in an example.

As shown in FIG. 4A, GUI 400 may include graphical elements 402A and 402B that correspond to users who are available and/or overdue for a fit test. In some examples, one or more of graphical elements 402 may indicate names of the users. In some examples, one or more of graphical elements 402 may indicate the date representing a deadline for the user to perform a fit-test. In some examples, one or more of graphical elements 402 may be selectable in response to a user input. For example, if a user provided a user input at mobile computing device 106 to select graphical element 402A, mobile computing device 106 may cause other graphical elements and/or another graphical user interface to be displayed. As an example, a user may provide a user input to select graphical element 402A which causes mobile computing device 106 to output graphical user interface 450 for display, as shown in FIG. 4B.

FIG. 4B illustrates a graphical user interface (GUI) 450 that enable a user to start a fit test, in accordance with techniques of this disclosure. As shown in FIG. 4B, GUI 450 may include graphical element 452. Graphical element 452 may include respirator information about the respirator that will be used in the fit test. In some examples, graphical element 452 may include a set of graphical elements which instructs the user on the donning procedure for the respirator. In examples, the respirator information may include an image of the respirator, a model of the respirator, and/or a date when the respirator was last fit-tested. In some examples, GUI 450 may include graphical element 454. Graphical element 454 may be selected in response to a user input and start a fit-test for the user. In some examples, GUI 450 may include graphical element 456. Graphical element 456 may be selected in response to a user input and enable the user to input or otherwise select another respirator to perform the fit-test. In some examples, additional graphical elements may exist for selection, which when selected provides instructions for donning the respirator. In some examples, additional graphical elements may exist for selection, which when selected provides information about the fit test to be performed.

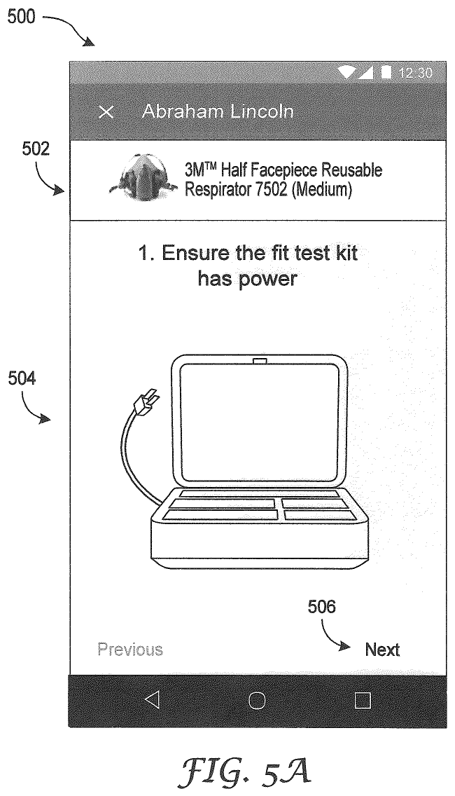

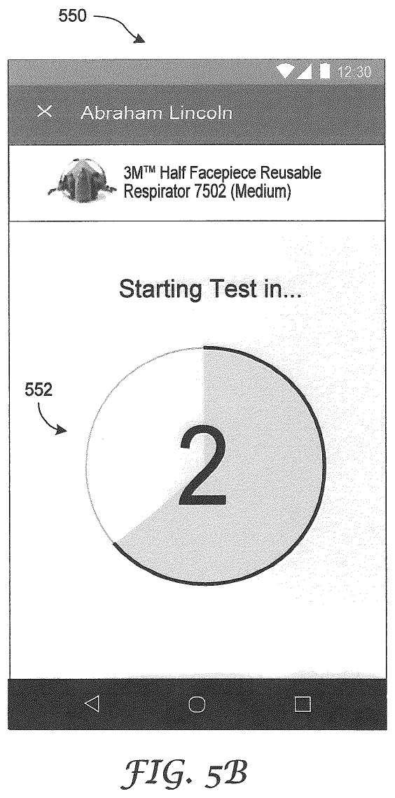

In response to a user input that selects graphical element 454, mobile computing device 106 may send one or more messages to aerosol generator device 110. The one or more messages may change the operation of aerosol generator device 110, such as by initiating the generation and provisioning of an aerosol with particulate matter to enclosure 120. In some examples, in response to a user input that selects graphical element 454, mobile computing device 106 may output one or more other graphical elements and/or another graphical user interface, such as GUI 500 in FIG. 5A.

FIG. 5A illustrates a graphical user interface (GUI) 500 that outputs diagnostic information for an aerosol generator device, in accordance with techniques of this disclosure. As shown in FIG. 5A, GUI 500 may include graphical element 502. Graphical element 502 may include respirator information about the respirator that will be used in the fit test. In examples, the respirator information may include an image of the respirator, a model of the respirator, and/or a date when the respirator was last fit-tested. In some examples, GUI 500 may include graphical element 504. Graphical element 504 may include diagnostic information for aerosol generator device 110. For example, graphical element 504 may indicate one or more instructions for a user to perform before initiating the fit test. In some examples, graphical element 504 may indicate a state or status of aerosol generator device 110. In some examples, GUI 500 may include graphical element 506, which may be selected by a user. In response to receiving user input that selects graphical element 506, mobile computing device 106 may output one or more other graphical elements and/or graphical user interfaces, such as GUI 550 in FIG. 5B.

In response to a user input that selects graphical element 506, mobile computing device 106 may send one or more messages to aerosol generator device 110. The one or more messages may change the operation of aerosol generator device 110, such as by initiating the generation and provisioning of an aerosol with particulate matter to enclosure 120. In some examples, in response to a user input that selects graphical element 506, mobile computing device 106 may output one or more other graphical elements and/or another graphical user interface, such as GUI 550 in FIG. 5B.

FIG. 5B illustrates a graphical user interface (GUI) 550 that outputs a start status for a fit test, in accordance with techniques of this disclosure. As shown in FIG. 5B, GUI 550 may include graphical element 552. Graphical element 552 may include a countdown timer or other indication of an amount of time before the fit test begins. In some examples, graphical element 552 may be an image or set of moving images. In response to expiration of an amount of time indicated by graphical element 552, mobile computing device 106 may send one or more messages to aerosol generator device 110. The one or more messages may change the operation of aerosol generator device 110, such as by initiating the generation and provisioning of an aerosol with particulate matter to enclosure 120. In some examples, in response to expiration of an amount of time indicated by graphical element 552, mobile computing device 106 may output one or more other graphical elements and/or another graphical user interface, such as GUI 600 in FIG. 6A.

FIG. 6A illustrates a graphical user interface (GUI) 600 that outputs an aerosol generating status, in accordance with techniques of this disclosure. As shown in FIG. 6A, GUI 600 may include graphical element 604. Graphical element 604 may indicate a stage of a fit test. In some examples, a fit test may include a set of one or more stages. Each stage may include one or more actions to be performed by the user of the respirator. In the example FIG. 6A, graphical element 604 may indicate the number or identifier of the current stage (e.g. “1”) of the fit test for which the user is performing a corresponding action. In some examples, graphical element 604 may indicate the total number of stages (“8”). In some examples, graphical element 604 may indicate an amount of time remaining in the stage of the fit test. In some examples, graphical element 604 may indicate an amount of time elapsed in the stage of the fit test. GUI 600 may also include graphical element 606. Graphical element 606 may indicate information about the current stage (e.g., “Filling hood with aerosol”) or an instruction to the user of the respirator in the fit test. In some examples, GUI 600 may include graphical element 608. Graphical element 608 may indicate visual information about the respirator, user, or action of the user. For instance, graphical element 608 may be an image or set of moving images that illustrate and/or instruct the user on one or more actions to complete in the current stage of the fit test. In some examples, graphical element 608 may illustrate the user's movements or actions in real-time or near-real-time as mobile computing device 106 receives data that indicates movements or other actions of the user of the respirator. In response to mobile computing device 106 determining that one or more actions for a stage were completed successfully and therefore the fit test was satisfied for that stage, mobile computing device 106 may output one or more other graphical elements and/or another graphical user interface, such as GUI 650 in FIG. 6B.

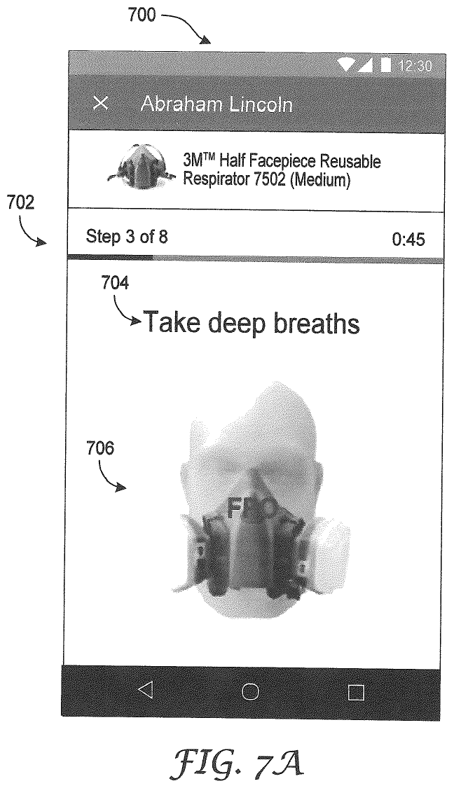

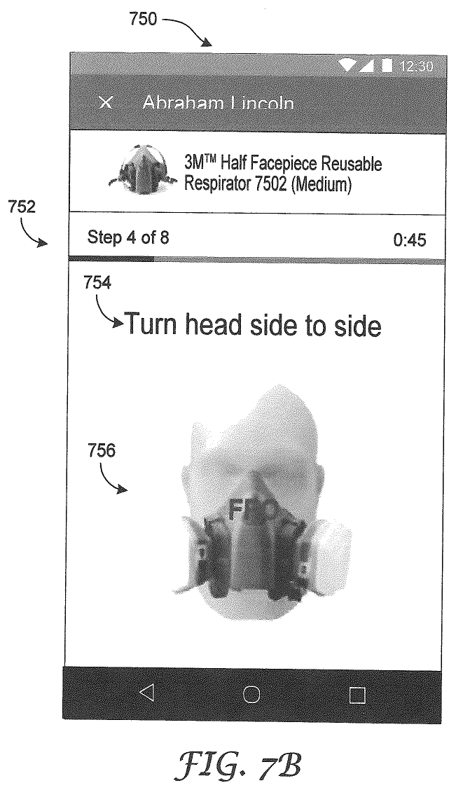

FIGS. 6B and 7A illustrate graphical user interfaces (GUI) 650 and 700 that output breathing actions for a fit test, in accordance with techniques of this disclosure. GUIs 650 and 700 may output graphical elements 652 and 702, respectively, which may include similar or the same functionality and/or content as graphical element 604 in GUI 600. GUI 650 and GUI 700 may output graphical elements 654 and 704, respectively, which indicate particular types of breathing that the user is instructed to engage in for each respective stage of the fit test (e.g., “Breathe Normally” and “Take deep breaths”). Coincident with the output of graphical element 654 or 704, mobile computing device 106 may also output audible and/or haptic feedback to the user, such as a bell, chime, verbal instruction and/or vibration to draw the user's attention to the GUI and the action to be performed during that stage. GUIs 650 and 700 may include graphical elements 656 and 706, which may include similar or the same functionality and/or content as graphical element 608 of GUI 600. In response to mobile computing device 106 determining that one or more actions for the stages indicated in GUIs 650 and 700 were completed successfully and therefore the fit test was satisfied for those respective stages, mobile computing device 106 may output one or more other graphical elements and/or other graphical user interfaces, such as GUI 700 or GUI 750.

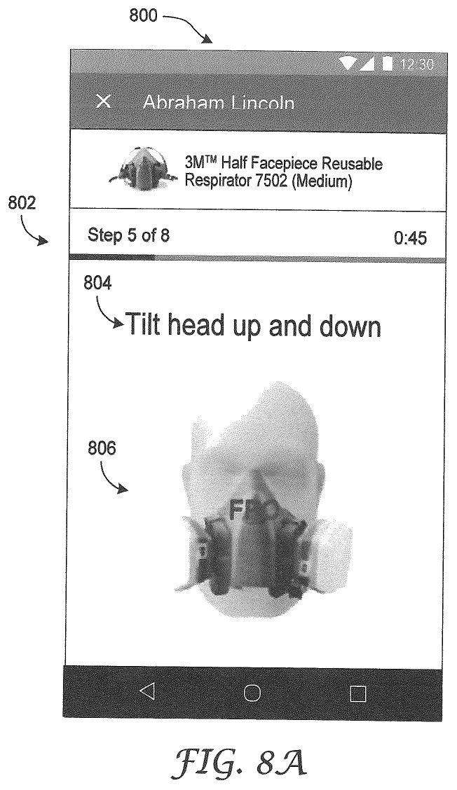

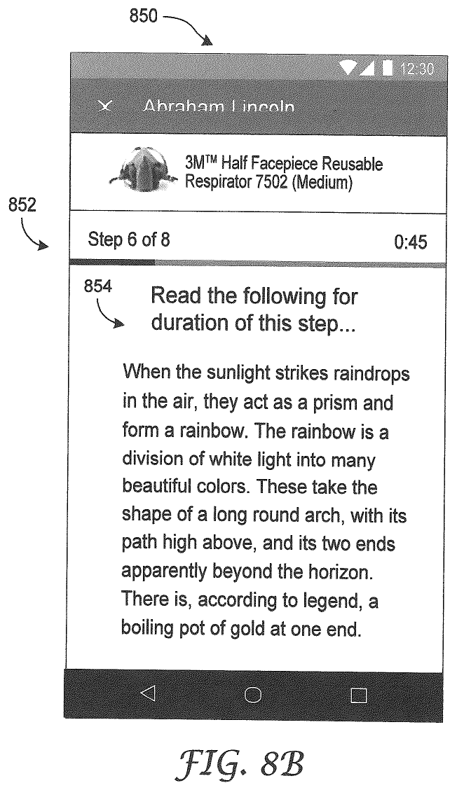

FIGS. 7B and 8A illustrate graphical user interfaces (GUI) 750 and 800 that output head motion actions for a fit test, in accordance with techniques of this disclosure. GUIs 750 and 800 may output graphical elements 752 and 802, respectively, which may include similar or the same functionality and/or content as graphical element 604 in GUI 600. GUI 750 and GUI 800 may output graphical elements 754 and 804, respectively, which indicate particular types of head motion actions that the user is instructed to engage in for each respective stage of the fit test (e.g., “Turn Head Side to Side” and “Tilt head up and down”). Coincident with the output of graphical element 754 or 804, mobile computing device 106 may also output audible and/or haptic feedback to the user, such as a bell, chime, verbal instruction and/or vibration to draw the user's attention to the GUI and the action to be performed during that stage. GUIs 750 and 800 may include graphical elements 756 and 806, which may include similar or the same functionality and/or content as graphical element 608 of GUI 600. In response to mobile computing device 106 determining that one or more actions for the stages indicated in GUIs 750 and 800 were completed successfully and therefore the fit test was satisfied for those respective stages, mobile computing device 106 may output one or more other graphical elements and/or other graphical user interfaces, such as GUI 800 or GUI 850.

FIG. 8B illustrates a graphical user interface (GUI) 850 that outputs mouth motion actions for a fit test, in accordance with techniques of this disclosure. GUI 850 may output graphical element 852, which may include similar or the same functionality and/or content as graphical element 604 in GUI 600. Graphical element 852 may indicate particular mouth motion actions that the user is instructed to engage in for the current stage of the fit test (e.g., “Read the following for the duration of this step . . . ”). Coincident with the output of graphical element 852, the mobile computing device 106 may also output audible and/or haptic feedback to the user, such as a bell, chime, verbal instruction and/or vibration to draw the user's attention to the GUI and the action to be performed during the stage. In response to mobile computing device 106 determining that one or more actions for current stage indicated in GUI 850 was completed successfully and therefore the fit test was satisfied for this respective stage, mobile computing device 106 may output one or more other graphical elements and/or other graphical user interfaces, such as GUI 900.

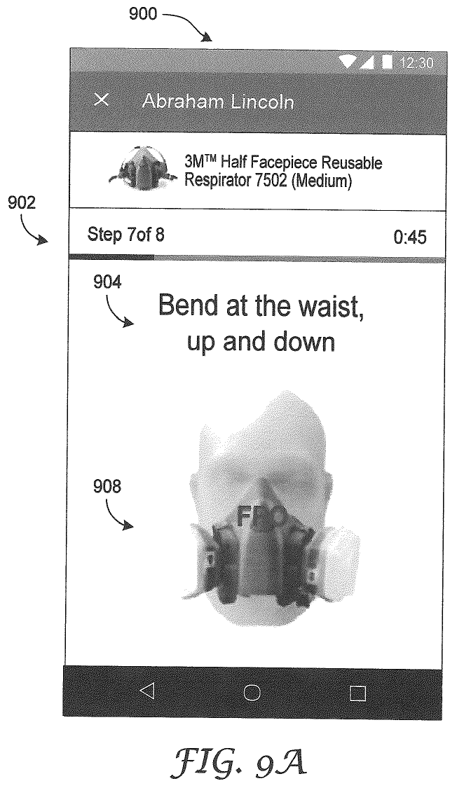

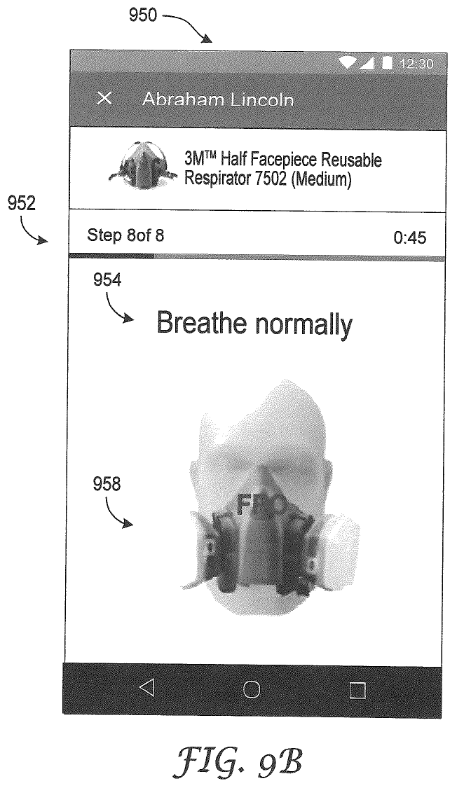

FIGS. 9A and 9B illustrate graphical user interfaces (GUI) 900 and 950 that output body and breathing actions for a fit test, in accordance with techniques of this disclosure. GUIs 900 and 950 may output graphical elements 904 and 954, respectively, which may include similar or the same functionality and/or content as graphical element 604 in GUI 600. GUIs 900 and 950 may include graphical elements 906 and 956 that indicate particular types of body and breathing actions that the user is instructed to engage in for each respective stage of the fit test (e.g., “Bend at the waist, up and down” and “Breathe normally”). Coincident with the output of graphical element 906 or 956, the mobile computing device 106 may also output audible and/or haptic feedback to the user, such as a bell, chime, verbal instruction and/or vibration to draw the user's attention to the GUI and the action to be performed during that stage. GUIs 900 and 950 may include graphical elements 908 and 958, which may include similar or the same functionality and/or content as graphical element 608 of GUI 600. In response to mobile computing device 106 determining that one or more actions for the stages indicated in GUIs 900 and 950 were completed successfully and therefore the fit test was satisfied for those respective stages, mobile computing device 106 may output one or more other graphical elements and/or other graphical user interfaces, such as GUI 950, 1000, or 1050.

FIGS. 10A and 10B illustrate graphical user interfaces (GUI) 1000 and 1050 that output whether fit test was satisfied or not satisfied, in accordance with techniques of this disclosure. Coincident with the output of GUI 1000 or 1050, the mobile computing device 106 may also output audible and/or haptic feedback to the user, such as a bell, chime, verbal instruction and/or vibration to draw the user's attention to the GUI and the fact that the test has ended so they can stop the action initiated during the preceding stage of the test. GUIs 1000 and 1050 may include graphical elements 1002 and 1052 respectively. Graphical elements 1002 and 1052 may include information that indicates whether the fit test was satisfied (e.g., “Passed”) or not satisfied (e.g., “Failed, Leak Detected”). In some examples, a fit test may be satisfied when each action for each stage in the fit test is completed without detecting particulate matter that satisfies a threshold. In the example of FIG. 10A, GUI 1000 may include graphical element 1004. Graphical element 1004 may include information about the fit test, next actions to be taken by the user, or any other information related to the fit test, user, and/or respirator. In some examples, if a fit test is satisfied, mobile computing device 106 may generate a certificate or other information that indicates the fit test was satisfied. GUI 1000 may include graphical element 1006 that, when selected by user input, causes mobile computing device 106 to display the certificate or other information. In other examples, graphical element 1006 may, when selected by user input, cause mobile computing device 106 to perform one or more operations, such but not limited to: storing the information indicating the fit test was satisfied, sending the information indicating the fit test was satisfied to another computing device, or any other suitable operation.

In some examples, mobile computing device 106 may determine that the fit test was not satisfied. Accordingly, mobile computing device 106 may output GUI 1050 for display in response to determining that the fit test was not satisfied. In some examples, mobile computing device 106 may determine at least one remedial recommendation to satisfy the fit test, as described in this disclosure. Mobile computing device 106 may output one or more remedial recommendations in graphical element(s) 1054. In some examples, GUI 1050 may include graphical element 1056, which when selected in response to user input, causes mobile computing device 106 to generate an audible alert. In some examples, GUI 1050 may include graphical element 1056, which when selected in response to user input, causes mobile computing device 106 to generate a message and communicate the message to another computing device, such as via SMS messaging. In some examples, GUI 1050 may include graphical element 1058, which when selected in response to user input, may cause mobile computing device 106 to re-run a fit test.

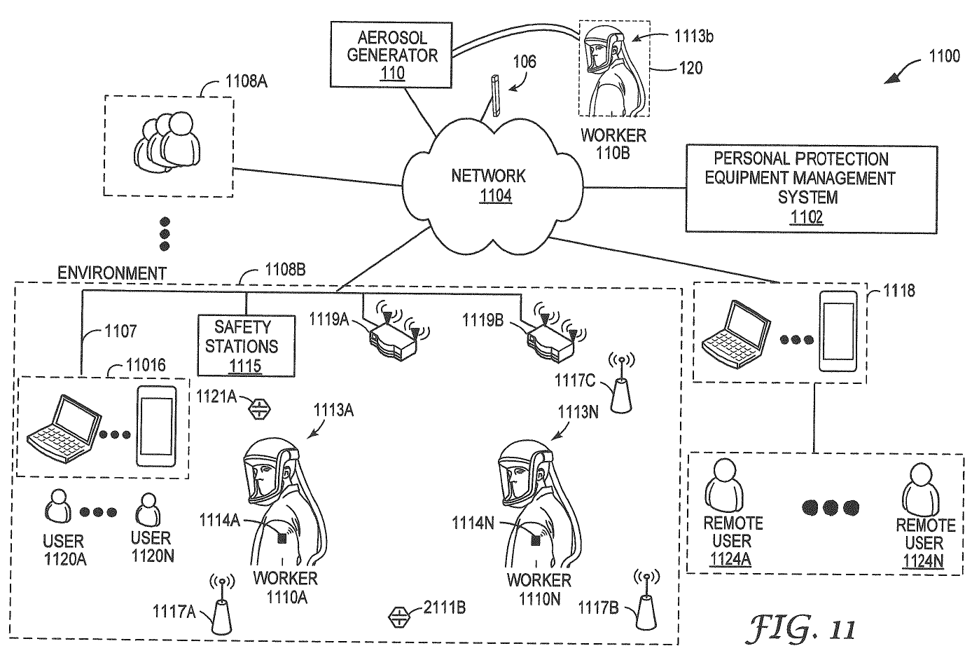

FIG. 11 is a block diagram illustrating an example computing system 1100 that includes a personal protection equipment management system (PPEMS) 1102 for managing personal protection equipment. As described herein, PPEMS 1102 allows authorized users to perform preventive occupational health and safety actions and manage inspections and maintenance of safety protective equipment. By interacting with PPEMS 1102, safety professionals can, for example, manage area inspections, worker inspections, worker health and safety compliance training.

In general, PPEMS 1102 provides data acquisition, monitoring, activity logging, reporting, predictive analytics, PPE control, and alert generation. For example, PPEMS 1102 includes an underlying analytics and safety event prediction engine and alerting system in accordance with various examples described herein. In general, a safety event may refer to activities of a user of personal protective equipment (PPE), a condition of the PPE, or an environmental condition (e.g., which may be hazardous). In some examples, a safety event may include a fit test that is satisfied or a fit test that is not satisfied. In some examples, a safety event may include a stage at which a fit test was not satisfied.

In some examples, a safety event may be an injury or worker condition, workplace harm, or regulatory violation. For example, in the context of fall protection equipment, a safety event may be misuse of the fall protection equipment, a user of the fall equipment experiencing a fall, or a failure of the fall protection equipment. In the context of a respirator, a safety event may be misuse of the respirator, a user of the respirator not receiving an appropriate quality and/or quantity of air, or failure of the respirator. A safety event may also be associated with a hazard in the environment in which the PPE is located. In some examples, occurrence of a safety event associated with the article of PPE may include a safety event in the environment in which the PPE is used or a safety event associated with a worker using the article of PPE. In some examples, a safety event may be an indication that PPE, a worker, and/or a worker environment are operating, in use, or acting in a way that is normal operation, where normal operation is a predetermined or predefined condition of acceptable or safe operation, use, or activity. In some examples, a safety event may be an indication of an unsafe condition, wherein the unsafe condition represents a state outside of a set of defined thresholds, rules, or other limits configured by a human operator and/or are machine-generated.

Examples of PPE include, but are not limited to respiratory protection equipment (including disposable respirators, reusable respirators, powered air purifying respirators, and supplied air respirators), protective eyewear, such as visors, goggles, filters or shields (any of which may include augmented reality functionality), protective headwear, such as hard hats, hoods or helmets, hearing protection (including ear plugs and ear muffs), protective shoes, protective gloves, other protective clothing, such as coveralls and aprons, protective articles, such as sensors, safety tools, detectors, global positioning devices, mining cap lamps, fall protection harnesses, exoskeletons, self-retracting lifelines, heating and cooling systems, gas detectors, and any other suitable gear. In some examples, a data hub, such as data 1114N may be an article of PPE.

As further described below, PPEMS 1102 provides an integrated suite of personal safety protection equipment management tools and implements various techniques of this disclosure. That is, PPEMS 1102 provides an integrated, end-to-end system for managing personal protection equipment, e.g., safety equipment, used by workers 1110 within one or more physical environments 1108, which may be construction sites, mining or manufacturing sites or any physical environment. The techniques of this disclosure may be realized within various parts of computing system 1100.

As shown in the example of FIG. 11, computing system 1100 represents a computing environment in which a computing device within of a plurality of physical environments 1108A, 1108B (collectively, environments 1108) electronically communicate with PPEMS 1102 via one or more computer networks 1104. Each of physical environment 1108 represents a physical environment, such as a work environment, in which one or more individuals, such as workers 1110, utilize personal protection equipment while engaging in tasks or activities within the respective environment.

In this example, environment 1108A is shown as generally as having workers, while environment 1108B is shown in expanded form to provide a more detailed example. In the example of FIG. 11, a plurality of workers 1110A-1110N are shown as utilizing respective respirators 1113A-1113N.

As further described herein, each of respirators 1113 includes embedded sensors or monitoring devices and processing electronics configured to capture data in real-time as a user (e.g., worker) engages in activities while wearing the respirators. For example, as described in greater detail herein, respirators 1113 may include a number of components (e.g., a head top, a blower, a filter, and the like) respirators 1113 may include a number of sensors for sensing or controlling the operation of such components. A head top may include, as examples, a head top visor position sensor, a head top temperature sensor, a head top motion sensor, a head top impact detection sensor, a head top position sensor, a head top battery level sensor, a head top head detection sensor, an ambient noise sensor, or the like. A blower may include, as examples, a blower state sensor, a blower pressure sensor, a blower run time sensor, a blower temperature sensor, a blower battery sensor, a blower motion sensor, a blower impact detection sensor, a blower position sensor, or the like. A filter may include, as examples, a filter presence sensor, a filter type sensor, or the like. Each of the above-noted sensors may generate usage data, as described herein.

In addition, each of respirators 1113 may include one or more output devices for outputting data that is indicative of operation of respirators 1113 and/or generating and outputting communications to the respective worker 1110. For example, respirators 1113 may include one or more devices to generate audible feedback (e.g., one or more speakers), visual feedback (e.g., one or more displays, light emitting diodes (LEDs) or the like), or tactile feedback (e.g., a device that vibrates or provides other haptic feedback).

In general, each of environments 1108 include computing facilities (e.g., a local area network) by which respirators 1113 are able to communicate with PPEMS 1102. For example, environments 1108 may be configured with wireless technology, such as 802.11 wireless networks, 802.15 ZigBee networks, and the like. In the example of FIG. 11, environment 1108B includes a local network 1107 that provides a packet-based transport medium for communicating with PPEMS 1102 via network 1104. In addition, environment 1108B includes a plurality of wireless access points 1119A, 1119B that may be geographically distributed throughout the environment to provide support for wireless communications throughout the work environment.

Each of respirators 1113 is configured to communicate data, such as sensed motions, events and conditions, via wireless communications, such as via 802.11 WiFi protocols, Bluetooth protocol or the like. Respirators 1113 may, for example, communicate directly with a wireless access point 1119. As another example, each worker 1110 may be equipped with a respective one of wearable communication hubs 1114A-1114N that enable and facilitate communication between respirators 1113 and PPEMS 1102. For example, respirators 1113 as well as other PPEs (such as fall protection equipment, hearing protection, hardhats, or other equipment) for the respective worker 1110 may communicate with a respective communication hub 1114 via Bluetooth or other short range protocol, and the communication hubs may communicate with PPEMS 1102 via wireless communications processed by wireless access points 1119. Although shown as wearable devices, hubs 1114 may be implemented as stand-alone devices deployed within environment 1108B. In some examples, hubs 1114 may be articles of PPE. In some examples, communication hubs 1114 may be an intrinsically safe computing device, smartphone, wrist- or head-wearable computing device, or any other computing device.

In general, each of hubs 1114 operates as a wireless device for respirators 1113 relaying communications to and from respirators 1113, and may be capable of buffering usage data in case communication is lost with PPEMS 1102. Moreover, each of hubs 1114 is programmable via PPEMS 1102 so that local alert rules may be installed and executed without requiring a connection to the cloud. As such, each of hubs 1114 provides a relay of streams of usage data from respirators 1113 and/or other PPEs within the respective environment, and provides a local computing environment for localized alerting based on streams of events in the event communication with PPEMS 1102 is lost.

As shown in the example of FIG. 11, an environment, such as environment 1108B, may also include one or more wireless-enabled beacons, such as beacons 1117A-1117C, that provide accurate location information within the work environment. For example, beacons 1117A-1117C may be GPS-enabled such that a controller within the respective beacon may be able to precisely determine the position of the respective beacon. Based on wireless communications with one or more of beacons 1117, a given respirator 1113 or communication hub 1114 worn by a worker 1110 is configured to determine the location of the worker within work environment 1108B. In this way, event data (e.g., usage data) reported to PPEMS 1102 may be stamped with positional information to aid analysis, reporting and analytics performed by PPEMS 1102.

In addition, an environment, such as environment 1108B, may also include one or more wireless-enabled sensing stations, such as sensing stations 1121A, 1121B. Each sensing station 1121 includes one or more sensors and a controller configured to output data indicative of sensed environmental conditions. Moreover, sensing stations 1121 may be positioned within respective geographic regions of environment 1108B or otherwise interact with beacons 1117 to determine respective positions and include such positional information when reporting environmental data to PPEMS 1102. As such, PPEMS 1102 may be configured to correlate the sense environmental conditions with the particular regions and, therefore, may utilize the captured environmental data when processing event data received from respirators 1113. For example, PPEMS 1102 may utilize the environmental data to aid generating alerts or other instructions for respirators 1113 and for performing predictive analytics, such as determining any correlations between certain environmental conditions (e.g., heat, humidity, visibility) with abnormal worker behavior or increased safety events. As such, PPEMS 1102 may utilize current environmental conditions to aid prediction and avoidance of imminent safety events. Example environmental conditions that may be sensed by sensing stations 1121 include but are not limited to temperature, humidity, presence of gas, pressure, visibility, wind and the like.

In example implementations, an environment, such as environment 1108B, may also include one or more safety stations 1115 distributed throughout the environment to provide viewing stations for accessing respirators 1113. Safety stations 1115 may allow one of workers 1110 to check out respirators 1113 and/or other safety equipment, verify that safety equipment is appropriate for a particular one of environments 1108, and/or exchange data. For example, safety stations 1115 may transmit alert rules, software updates, or firmware updates to respirators 1113 or other equipment. Safety stations 1115 may also receive data cached on respirators 1113, hubs 1114, and/or other safety equipment. That is, while respirators 1113 (and/or data hubs 1114) may typically transmit usage data from sensors of respirators 1113 to network 1104 in real time or near real time, in some instances, respirators 1113 (and/or data hubs 1114) may not have connectivity to network 1104. In such instances, respirators 1113 (and/or data hubs 1114) may store usage data locally and transmit the usage data to safety stations 1115 upon being in proximity with safety stations 1115. Safety stations 1115 may then upload the data from respirators 1113 and connect to network 1104.

In addition, each of environments 1108 include computing facilities that provide an operating environment for end-user computing devices 1116 for interacting with PPEMS 1102 via network 1104. For example, each of environments 1108 typically includes one or more safety managers responsible for overseeing safety compliance within the environment. In general, each user 1120 interacts with computing devices 1116 to access PPEMS 1102. Each of environments 1108 may include systems. Similarly, remote users may use computing devices 1118 to interact with PPEMS via network 1104. For purposes of example, the end-user computing devices 1116 may be laptops, desktop computers, mobile devices such as tablets or so-called smart phones and the like.

Users 1120, 1124 interact with PPEMS 1102 to control and actively manage many aspects of safety equipment utilized by workers 1110, such as accessing and viewing usage records, analytics and reporting. For example, users 1120, 1124 may review usage information acquired and stored by PPEMS 1102, where the usage information may include data specifying starting and ending times over a time duration (e.g., a day, a week, or the like), data collected during particular events, such as lifts of a visor of respirators 1113, removal of respirators 1113 from a head of workers 1110, changes to operating parameters of respirators 1113, status changes to components of respirators 1113 (e.g., a low battery event), motion of workers 1110, detected impacts to respirators 1113 or hubs 1114, sensed data acquired from the user, environment data, whether fit tests were satisfied or not satisfied and the like. In addition, users 1120, 1124 may interact with PPEMS 1102 to perform asset tracking, to schedule maintenance events for individual pieces of safety equipment, e.g., respirators 1113, or schedule and/or verify fit tests to ensure compliance with any procedures or regulations. PPEMS 1102 may allow users 1120, 1124 to create and complete digital checklists with respect to the maintenance procedures and to synchronize any results of the procedures from computing devices 1116, 1118 to PPEMS 1102.

Further, as described herein, PPEMS 1102 integrates an event processing platform configured to process thousand or even millions of concurrent streams of events from digitally enabled PPEs, such as respirators 1113. An underlying analytics engine of PPEMS 1102 applies historical data and models to the inbound streams to compute assertions, such as identified anomalies or predicted occurrences of safety events based on conditions or behavior patterns of workers 1110. Further, PPEMS 1102 provides real-time alerting and reporting to notify workers 1110 and/or users 1120, 1124 of any predicted events, anomalies, trends, and the like.

The analytics engine of PPEMS 1102 may, in some examples, apply analytics to identify relationships or correlations between sensed worker data, environmental conditions, geographic regions and other factors and analyze the impact on safety events. PPEMS 1102 may determine, based on the data acquired across populations of workers 1110, which particular activities, including fit tests, possibly within certain geographic region, lead to, or are predicted to lead to, unusually high occurrences of safety events.

In this way, PPEMS 1102 tightly integrates comprehensive tools for managing personal protection equipment with an underlying analytics engine and communication system to provide data acquisition, monitoring, activity logging, reporting, behavior analytics and alert generation. Moreover, PPEMS 1102 provides a communication system for operation and utilization by and between the various elements of system 1100. Users 1120, 1124 may access PPEMS 1102 to view results on any analytics performed by PPEMS 1102 on data acquired from workers 1110. In some examples, PPEMS 1102 may present a web-based interface via a web server (e.g., an HTTP server) or client-side applications may be deployed for devices of computing devices 1116, 1118 used by users 1120, 1124, such as desktop computers, laptop computers, mobile devices such as smartphones and tablets, or the like.

In some examples, PPEMS 1102 may provide a database query engine for directly querying PPEMS 1102 to view acquired safety information, compliance information and any results of the analytic engine, e.g., by the way of dashboards, alert notifications, reports and the like. That is, users 1124, 1126, or software executing on computing devices 1116, 1118, may submit queries to PPEMS 1102 and receive data corresponding to the queries for presentation in the form of one or more reports or dashboards comprised of one or more graphical elements and/or graphical user interfaces. Such dashboards may provide various insights regarding system 1100, including fit tests, such as baseline (“normal”) operation across worker populations, identifications of any anomalous workers engaging in abnormal activities that may potentially expose the worker to risks, identifications of any geographic regions within environments 2 for which unusually anomalous (e.g., high) safety events have been or are predicted to occur, identifications of any of environments 2 exhibiting anomalous occurrences of safety events relative to other environments, and the like.

As illustrated in detail below, PPEMS 1102 may simplify workflows for individuals charged with monitoring and ensure safety compliance for an entity or environment. That is, the techniques of this disclosure may enable active safety management and allow an organization to take preventative or correction actions with respect to certain regions within environments 1108, particular pieces of safety equipment or individual workers 1110, define and may further allow the entity to implement workflow procedures that are data-driven by an underlying analytical engine.

As one example, the underlying analytical engine of PPEMS 1102 may be configured to compute and present customer-defined metrics for worker populations, such as relating to fit tests, within a given environment 1108 or across multiple environments for an organization as a whole. For example, PPEMS 1102 may be configured to acquire data and provide aggregated performance metrics and/or predictive analytics across a worker population (e.g., across workers 1110 of either or both of environments 1108A, 1108B). Furthermore, users 1120, 1124 may set benchmarks for occurrence of any safety incidences, and PPEMS 1102 may track actual performance metrics relative to the benchmarks for individuals or defined worker populations.

In some examples, PPEMS 1102 may identify individual respirators 1113 or workers 1110 for which fit-test metrics do not meet the benchmarks and prompt the users to intervene and/or perform procedures, such as training or other activities, to improve the metrics relative to the benchmarks, thereby ensuring compliance and actively managing safety for workers 1110. A sensor included in respirator 1113B may include an electric circuit configured to determine a change in at least one electrical characteristic of a sensing element. In some examples, the change in the at least one electrical characteristic is based at least in part on detection of particulate matter. Respirator 1113B may include a communication component configured to communicate data that is based at least in part on the change in the at least one electrical characteristic of the sensing element.

As part of a fit test, respirator 1113B may communicate wirelessly with mobile computing device 106. During the fit test, mobile computing device 106 may output for display, based at least in part on a determination that particulate matter has been provided in proximity to the respirator, at least one graphical element in a set of graphical elements. In some examples, mobile computing device 106 may receive data that is based at least in part on a change in at least one electrical characteristic of the sensing element in a sensor of respirator 1113B. For instance, based on the presence of particulate matter generated in an aerosol generator device 110 and present at the sensing element, a change in an electrical characteristic (e.g., impedance) may be determined by the sensor and sent as data to mobile computing device 106. Mobile computing device 106 may determine, during at least one action that corresponds to the at least one graphical element and is performed by the user, whether the fit test was satisfied.

In some examples, mobile computing device 106 may, while performing the fit test, output a set of graphical user interfaces that guide the user through each stage of the fit test. Such examples are further illustrated in this disclosure. If a user completes a stage of the fit test and mobile computing device 106 determines that no leak has occurred that would cause the fit test to not be satisfied, mobile computing device 106 may output for display one or more other graphical elements or graphical user interfaces that correspond to other stages of the fit test. Accordingly, in response to the determination whether the fit test was satisfied, mobile computing device 106 may perform at least one operation that is based at least in part on the determination whether the fit test was satisfied. If the fit test was satisfied for a particular stage, then mobile computing device may output for display one or more other graphical elements or graphical user interfaces that correspond to other stages of the fit test. If, however, mobile computing device determines that the fit test was not satisfied for a particular stage, then mobile computing device may output for a display an indication that the fit test has failed. In some examples, mobile computing device 106 may perform one or more other operations described in this disclosure. In some examples, mobile computing device 106 may, determine, based at least in part on particular context data associated with the fit test, at least one remedial recommendation to satisfy the fit test. Mobile computing device 106 may output for display the at least one remedial recommendation to satisfy the fit test.

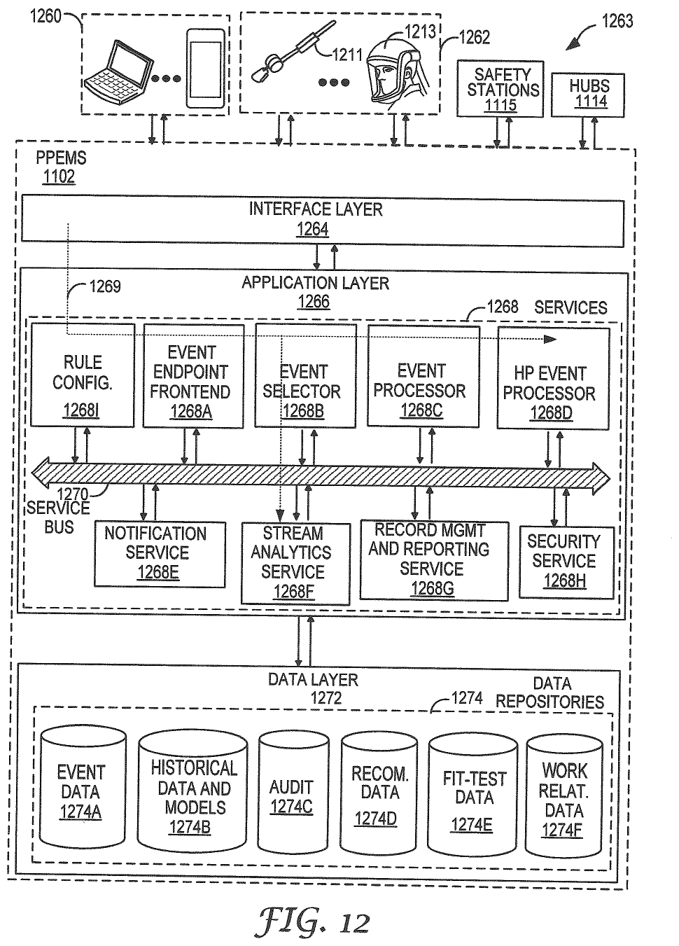

FIG. 12 is a block diagram providing an operating perspective of PPEMS 1102 when hosted as cloud-based platform capable of supporting multiple, distinct work environments 1108 having an overall population of workers 1110 that have a variety of communication enabled personal protection equipment (PPE), such as safety release lines (SRLs) 1211, respirators 1213, safety helmets, hearing protection or other safety equipment. In the example of FIG. 12, the components of PPEMS 1102 are arranged according to multiple logical layers that implement the techniques of the disclosure. Each layer may be implemented by a one or more modules comprised of hardware, software, or a combination of hardware and software.

In FIG. 12, personal protection equipment (PPEs) 1262, such as SRLs 1211, respirators 1213 and/or other equipment, either directly or by way of hubs 1114, as well as computing devices 1260, operate as clients 1263 that communicate with PPEMS 1102 via interface layer 1164. Computing devices 1260 typically execute client software applications, such as desktop applications, mobile applications, and web applications. Computing devices 1260 may represent any of computing devices 1116, 118 of FIG. 11. Examples of computing devices 1260 may include, but are not limited to a portable or mobile computing device (e.g., smartphone, wearable computing device, tablet), laptop computers, desktop computers, smart television platforms, and servers, to name only a few examples.

As further described in this disclosure, PPEs 1262 communicate with PPEMS 1102 (directly or via hubs 1114) to provide streams of data acquired from embedded sensors and other monitoring circuitry and receive from PPEMS 1102 alerts, configuration and other communications. Client applications executing on computing devices 1260 may communicate with PPEMS 1102 to send and receive information that is retrieved, stored, generated, and/or otherwise processed by services 1268. For instance, the client applications may request and edit safety event information including analytical data stored at and/or managed by PPEMS 1102. In some examples, client applications may request and display aggregate safety event information that summarizes or otherwise aggregates numerous individual instances of safety events, such as relating to fit tests, and corresponding data acquired from PPEs 1262 and/or generated by PPEMS 1102. The client applications may interact with PPEMS 1102 to query for analytics information about past and predicted safety events, behavior trends of workers 1110, to name only a few examples. In some examples, the client applications may output for display information received from PPEMS 1102 to visualize such information for users of clients 1263. As further illustrated and described in below, PPEMS 1102 may provide information to the client applications, which the client applications output for display in user interfaces.

Clients applications executing on computing devices 1260 may be implemented for different platforms but include similar or the same functionality. For instance, a client application may be a desktop application compiled to run on a desktop operating system, such as Microsoft Windows, Apple OS X, or Linux, to name only a few examples. As another example, a client application may be a mobile application compiled to run on a mobile operating system, such as Google Android, Apple iOS, Microsoft Windows Mobile, or BlackBerry OS to name only a few examples. As another example, a client application may be a web application such as a web browser that displays web pages received from PPEMS 1102. In the example of a web application, PPEMS 1102 may receive requests from the web application (e.g., the web browser), process the requests, and send one or more responses back to the web application. In this way, the collection of web pages, the client-side processing web application, and the server-side processing performed by PPEMS 1102 collectively provides the functionality to perform techniques of this disclosure. In this way, client applications use various services of PPEMS 1102 in accordance with techniques of this disclosure, and the applications may operate within various different computing environment (e.g., embedded circuitry or processor of a PPE, a desktop operating system, mobile operating system, or web browser, to name only a few examples).

As shown in FIG. 12, PPEMS 1102 includes an interface layer 1264 that represents a set of application programming interfaces (API) or protocol interface presented and supported by PPEMS 1102. Interface layer 1264 initially receives messages from any of clients 1263 for further processing at PPEMS 1102. Interface layer 1264 may therefore provide one or more interfaces that are available to client applications executing on clients 1263. In some examples, the interfaces may be application programming interfaces (APIs) that are accessible over a network. Interface layer 1264 may be implemented with one or more web servers. The one or more web servers may receive incoming requests, process and/or forward information from the requests to services 1268, and provide one or more responses, based on information received from services 1268, to the client application that initially sent the request. In some examples, the one or more web servers that implement interface layer 1264 may include a runtime environment to deploy program logic that provides the one or more interfaces. As further described below, each service may provide a group of one or more interfaces that are accessible via interface layer 1264.

In some examples, interface layer 1264 may provide Representational State Transfer (RESTful) interfaces that use HTTP methods to interact with services and manipulate resources of PPEMS 1102. In such examples, services 1268 may generate JavaScript Object Notation (JSON) messages that interface layer 1264 sends back to the client application that submitted the initial request. In some examples, interface layer 1264 provides web services using Simple Object Access Protocol (SOAP) to process requests from client applications 1261. In still other examples, interface layer 1264 may use Remote Procedure Calls (RPC) to process requests from clients 1263. Upon receiving a request from a client application to use one or more services 1268, interface layer 1264 sends the information to application layer 1266, which includes services 1268.

As shown in FIG. 12, PPEMS 1102 also includes an application layer 1266 that represents a collection of services for implementing much of the underlying operations of PPEMS 1102. Application layer 1266 receives information included in requests received from client applications 1261 and further processes the information according to one or more of services 1268 invoked by the requests. Application layer 1266 may be implemented as one or more discrete software services executing on one or more application servers, e.g., physical or virtual machines. That is, the application servers provide runtime environments for execution of services 1268. In some examples, the functionality interface layer 1264 as described above and the functionality of application layer 1266 may be implemented at the same server.

Application layer 1266 may include one or more separate software services 1268, e.g., processes that communicate, e.g., via a logical service bus 1270 as one example. Service bus 1270 generally represents a logical interconnections or set of interfaces that allows different services to send messages to other services, such as by a publish/subscription communication model. For instance, each of services 1268 may subscribe to specific types of messages based on criteria set for the respective service. When a service publishes a message of a particular type on service bus 1270, other services that subscribe to messages of that type will receive the message. In this way, each of services 1268 may communicate information to one another. As another example, services 1268 may communicate in point-to-point fashion using sockets or other communication mechanism. Before describing the functionality of each of services 1268, the layers are briefly described herein.

Data layer 1272 of PPEMS 1102 represents a data repository that provides persistence for information in PPEMS 1102 using one or more data repositories 1274. A data repository, generally, may be any data structure or software that stores and/or manages data. Examples of data repositories include but are not limited to relational databases, multi-dimensional databases, maps, and hash tables, to name only a few examples. Data layer 1272 may be implemented using Relational Database Management System (RDBMS) software to manage information in data repositories 1274. The RDBMS software may manage one or more data repositories 1274, which may be accessed using Structured Query Language (SQL). Information in the one or more databases may be stored, retrieved, and modified using the RDBMS software. In some examples, data layer 1272 may be implemented using an Object Database Management System (ODBMS), Online Analytical Processing (OLAP) database or other suitable data management system.

As shown in FIG. 12, each of services 1268A-1268I (“services 1268”) is implemented in a modular form within PPEMS 1102. Although shown as separate modules for each service, in some examples the functionality of two or more services may be combined into a single module or component. Each of services 1268 may be implemented in software, hardware, or a combination of hardware and software. Moreover, services 1268 may be implemented as standalone devices, separate virtual machines or containers, processes, threads or software instructions generally for execution on one or more physical processors.

In some examples, one or more of services 1268 may each provide one or more interfaces that are exposed through interface layer 1264. Accordingly, client applications of computing devices 1260 may call one or more interfaces of one or more of services 1268 to perform techniques of this disclosure.

In accordance with techniques of the disclosure, services 1268 may include an event processing platform including an event endpoint frontend 1268A, event selector 1268B, event processor 1268C and high priority (HP) event processor 1268D. Event endpoint frontend 1268A operates as a front-end interface for receiving and sending communications to PPEs 1262 and hubs 1114. In other words, event endpoint frontend 1268A operates to as a front-line interface to safety equipment deployed within environments 1108 and utilized by workers 1110. In some instances, event endpoint frontend 1268A may be implemented as a plurality of tasks or jobs spawned to receive individual inbound communications of event streams 1269 from the PPEs 1262 carrying data sensed and captured by the safety equipment. When receiving event streams 1269, for example, event endpoint frontend 1268A may spawn tasks to quickly enqueue an inbound communication, referred to as an event, and close the communication session, thereby providing high-speed processing and scalability. Each incoming communication may, for example, carry data recently captured data representing sensed conditions, motions, temperatures, actions or other data, generally referred to as events. Communications exchanged between the event endpoint frontend 1268A and the PPEs may be real-time or pseudo real-time depending on communication delays and continuity.

Event selector 1268B operates on the stream of events 1269 received from PPEs 1262 and/or hubs 1114 via frontend 1268A and determines, based on rules or classifications, priorities associated with the incoming events. Based on the priorities, event selector 1268B enqueues the events for subsequent processing by event processor 1268C or high priority (HP) event processor 1268D. Additional computational resources and objects may be dedicated to HP event processor 1268D so as to ensure responsiveness to critical events, such as incorrect usage of PPEs, use of incorrect filters and/or respirators based on geographic locations and conditions, failure to properly secure SRLs 1211 and the like. Responsive to processing high priority events, HP event processor 1268D may immediately invoke notification service 1268E to generate alerts, instructions, warnings or other similar messages to be output to SRLs 1211, respirators 1113, hubs 1114 and/or remote users. Events not classified as high priority are consumed and processed by event processor 1268C.

In general, event processor 1268C or high priority (HP) event processor 1268D operate on the incoming streams of events to update event data 1274A within data repositories 1274. In general, event data 1274A may include all or a subset of usage data obtained from PPEs 1262. For example, in some instances, event data 1274A may include entire streams of samples of data obtained from electronic sensors of PPEs 1262. In other instances, event data 74A may include a subset of such data, e.g., associated with a particular time period or activity of PPEs 1262.

Event processors 1268C, 1268D may create, read, update, and delete event information stored in event data 1274A. Event information for may be stored in a respective database record as a structure that includes name/value pairs of information, such as data tables specified in row/column format. For instance, a name (e.g., column) may be “worker ID” and a value may be an employee identification number. An event record may include information such as, but not limited to: worker identification, PPE identification, acquisition timestamp(s) and data indicative of one or more sensed parameters.

In addition, event selector 1268B directs the incoming stream of events to stream analytics service 1268F, which is configured to perform in depth processing of the incoming stream of events to perform real-time analytics. Stream analytics service 1268F may, for example, be configured to process and compare multiple streams of event data 1274A with historical data and models 1274B in real-time as event data 1274A is received. In this way, stream analytic service 1268D may be configured to detect anomalies, transform incoming event data values, trigger alerts upon detecting safety concerns based on conditions or worker behaviors. Historical data and models 1274B may include, for example, specified safety rules, business rules and the like. In addition, stream analytic service 1268D may generate output for communicating to PPPEs 1262 by notification service 1268F or computing devices 1260 by way of record management and reporting service 1268D.

In this way, analytics service 1268F processes inbound streams of events, potentially hundreds or thousands of streams of events, from enabled safety PPEs 1262 utilized by workers 1110 within environments 1108 to apply historical data and models 1274B to compute assertions, such as identified anomalies or predicted occurrences of imminent safety events based on conditions or behavior patterns of the workers. Analytics service 1268D may publish the assertions to notification service 1268F and/or record management by service bus 1270 for output to any of clients 1263.

In this way, analytics service 1268F may be configured as an active safety management system that predicts imminent safety concerns and provides real-time alerting and reporting. In addition, analytics service 1268F may be a decision support system that provides techniques for processing inbound streams of event data to generate assertions in the form of statistics, conclusions, and/or recommendations on an aggregate or individualized worker and/or PPE basis for enterprises, safety officers and other remote users. For instance, analytics service 1268F may apply historical data and models 74B to determine, for a particular worker, the likelihood that a safety event is imminent for the worker based on detected behavior or activity patterns, environmental conditions and geographic locations. In some examples, analytics service 1268F may determine whether a worker is currently impaired, e.g., due to exhaustion, sickness or alcohol/drug use, and may require intervention to prevent safety events. As yet another example, analytics service 1268F may provide comparative ratings of workers or type of safety equipment in a particular environment.

Hence, analytics service 1268F may maintain or otherwise use one or more models that provide risk metrics to predict safety events. Analytics service 1268F may also generate order sets, recommendations, and quality measures. In some examples, analytics service 1268F may generate user interfaces based on processing information stored by PPEMS 1102 to provide actionable information to any of clients 1263. For example, analytics service 1268F may generate dashboards, alert notifications, reports and the like for output at any of clients 1263. Such information may provide various insights regarding baseline (“normal”) operation across worker populations, identifications of any anomalous workers engaging in abnormal activities that may potentially expose the worker to risks, identifications of any geographic regions within environments for which unusually anomalous (e.g., high) safety events have been or are predicted to occur, identifications of any of environments exhibiting anomalous occurrences of safety events relative to other environments, and the like.

Although other technologies can be used, in one example implementation, analytics service 1268F utilizes machine learning when operating on streams of safety events so as to perform real-time analytics. That is, analytics service 1268F includes executable code generated by application of machine learning to training data of event streams and known safety events to detect patterns. The executable code may take the form of software instructions or rule sets and is generally referred to as a model that can subsequently be applied to event streams 1269 for detecting similar patterns and predicting upcoming events.

Analytics service 1268F may, in some example, generate separate models for a particular worker, a particular population of workers, a particular environment, or combinations thereof. Analytics service 1268F may update the models, such as for example fit testing or remedial recommendations, based on usage data received from PPEs 1262 including respirators. For example, analytics service 1268F may update the models for a particular worker, a particular population of workers, a particular environment, or combinations thereof based on data received from PPEs 1262. In some examples, usage data may include incident reports, air monitoring systems, manufacturing production systems, or any other information that may be used to a train a model.

Alternatively, or in addition, analytics service 1268F may communicate all or portions of the generated code and/or the machine learning models to hubs 16 (or PPEs 1262) for execution thereon so as to provide local alerting in near-real time to PPEs. Example machine learning techniques that may be employed to generate models 74B can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

Record management and reporting service 1268G processes and responds to messages and queries received from computing devices 1260 via interface layer 1264. For example, record management and reporting service 1268G may receive requests from client computing devices for event data related to individual workers, populations or sample sets of workers, geographic regions of environments 1108 or environments 1108 as a whole, individual or groups/types of PPEs 1262. In response, record management and reporting service 1268G accesses event information based on the request. Upon retrieving the event data, record management and reporting service 1268G constructs an output response to the client application that initially requested the information. In some examples, the data may be included in a document, such as an HTML document, or the data may be encoded in a JSON format or presented by a dashboard application executing on the requesting client computing device. For instance, as further described in this disclosure, example user interfaces that include the event information are depicted in the figures.

As additional examples, record management and reporting service 1268G may receive requests to find, analyze, and correlate PPE event information. For instance, record management and reporting service 1268G may receive a query request from a client application for event data 1274A over a historical time frame, such as a user can view PPE event information over a period of time and/or a computing device can analyze the PPE event information over the period of time.

In example implementations, services 1268 may also include security service 1268H that authenticate and authorize users and requests with PPEMS 1102. Specifically, security service 1268H may receive authentication requests from client applications and/or other services 1268 to access data in data layer 1272 and/or perform processing in application layer 1266. An authentication request may include credentials, such as a username and password. Security service 1268H may query security data 1274A to determine whether the username and password combination is valid. Recommendation data 1274D may include remedial recommendation data as described in FIG. 3.

Security service 1268H may provide audit and logging functionality for operations performed at PPEMS 1102. For instance, security service 1268H may log operations performed by services 1268 and/or data accessed by services 1268 in data layer 1272. Security service 1268H may store audit information such as logged operations, accessed data, and rule processing results in audit data 1274C. In some examples, security service 1268H may generate events in response to one or more rules being satisfied. Security service 1268H may store data indicating the events in audit data 1274C.

In the example of FIG. 12, a safety manager may initially configure one or more safety rules. As such, a remote user may provide one or more user inputs at a computing device that configure a set of safety rules for a work environment. For instance, a computing device of the safety manager may send a message that defines or specifies the safety rules and or fit tests. Such message may include data to select or create conditions and actions of the safety rules. PPEMS 1102 may receive the message at interface layer 1264 which forwards the message to rule configuration component 1268I. Rule configuration component 1268I may be combination of hardware and/or software that provides for rule configuration.

Fit-test data 317 may data as described in FIG. 3 and stored in any suitable data store such as a relational database system, online analytical processing database, object-oriented database, or any other type of data store. Such fit-test data may be used to perform population-level analytics on fit test data across multiple customers, sites, industry segments, users or other logical grouping or partition.

According to aspects of this disclosure, as noted above, PPEMS 1102 may apply analytics to predict the likelihood of a safety event, such as whether a fit-test was satisfied or not satisfied. As noted above, a safety event may refer to activities of a worker 1110 using PPE 1262, a condition of PPE 1262, or a hazardous environmental condition (e.g., that the likelihood of a safety event is relatively high, that the environment is dangerous, that SRL 11 is malfunctioning, that one or more components of SRL 11 need to be repaired or replaced, or the like), or whether a fit-test was satisfied or not. For example, PPEMS 1102 may determine the likelihood of a safety event based on application of usage data from PPE 1262 to historical data and models 1274B. That is, PPEMS 1102 may apply historical data and models 1274B to usage data (such as fit-test results) from respirators 1113 in order to compute assertions, such as anomalies or predicted occurrences of imminent safety events based on environmental conditions or behavior patterns of a worker using a respirator 1213.

PPEMS 1102 may apply analytics to identify relationships or correlations between data from respirators 1113, environmental conditions of environment in which respirators 1113 are located, a geographic region in which respirators 1113 are located, and/or other factors. PPEMS 1102 may determine, based on the data acquired across populations of workers 1110, which particular activities, possibly within certain environment or geographic region, lead to, or are predicted to lead to, unusually high occurrences of safety events, including fit tests that were not satisfied. PPEMS 1102 may generate alert data based on the analysis of the usage data and transmit the alert data to PPEs 1262 and/or hubs 1114 and/or other computing devices. Hence, according to aspects of this disclosure, PPEMS 1102 may determine usage data of respirator 1213, generate status indications, determine performance analytics, and/or perform prospective/preemptive actions based on a likelihood of a safety event. In some examples, the usage statistics may be used to determine when to generate remedial recommendations. For example, PPEMS 1102 may compare fit-test results in order to identify defects or anomalies. In other examples, PPEMS 1102 may also compare the fit-test results to provide an understanding how respirators 1113 are used by workers 1110 to product developers in order to improve product designs and performance. In still other examples, the usage statistics may be used to gathering human performance metadata to develop product specifications. In still other examples, the usage statistics may be used as a competitive benchmarking tool. For example, fit-test results may be compared between customers of respirators 1113 to evaluate metrics (e.g. productivity, compliance, or the like) between entire populations of workers outfitted with respirators 1113.

In general, while certain techniques or functions are described herein as being performed by certain components, e.g., PPEMS 1102, respirators 1113, or hubs 1114, it should be understood that the techniques of this disclosure are not limited in this way. That is, certain techniques described herein may be performed by one or more of the components of the described systems. For example, in some instances, respirators 1113 may have a relatively limited sensor set and/or processing power. In such instances, one of hubs 1114 and/or PPEMS 1102 may be responsible for most or all of the processing of usage data, determining the likelihood of a safety event, and the like. In other examples, respirators 1113 and/or hubs 1114 may have additional sensors, additional processing power, and/or additional memory, allowing for respirators 1113 and/or hubs 1114 to perform additional techniques. Determinations regarding which components are responsible for performing techniques may be based, for example, on processing costs, financial costs, power consumption, or the like.

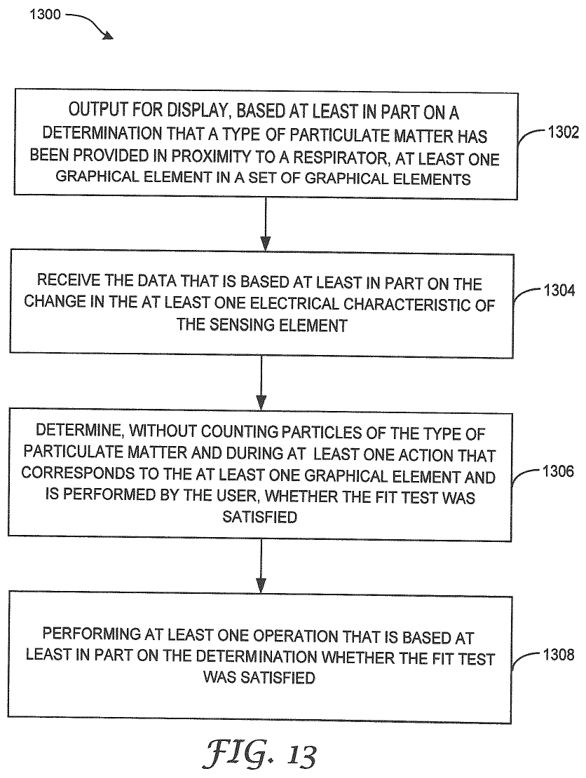

FIG. 13 is a flow diagram illustrating example operations of a wireless, respiratory fit-testing system, in accordance with one or more techniques of this disclosure. For purposes of illustration only, the example operations 1300 are described below within the context of mobile computing device 106. In some examples, mobile computing device 106 may output for display, based at least in part on a determination that particulate matter has been provided in proximity to a respirator, at least one graphical element in a set of graphical elements (1302). In some examples, each graphical element in the set of graphical elements corresponds to an action to be performed by a user in a fit test. In some examples, the respirator is worn by the user and a sensor is operatively coupled to the respirator comprising: an electric circuit configured to determine a change in at least one electrical characteristic of a sensing element. The change in the at least one electrical characteristic may be based at least in part on detection of particulate matter. The change in the at least one electrical characteristic may be based at least in part on changes in air pressure. The sensor may comprise a communication component that is configured to communicate data that is based at least in part on the change in the at least one electrical characteristic of the sensing element.

In some examples, mobile computing device 106 may receive the data that is based at least in part on the change in the at least one electrical characteristic of the sensing element (1304). In response to receiving the data, mobile computing device 106 may determine, without counting particles of particulate matter and during at least one action that corresponds to the at least one graphical element and is performed by the user, whether the fit test was satisfied (1306). In some examples, in response to determining whether the fit test was satisfied, mobile computing device 106 may perform at least one operation that is based at least in part on the determination whether the fit test was satisfied (1308).

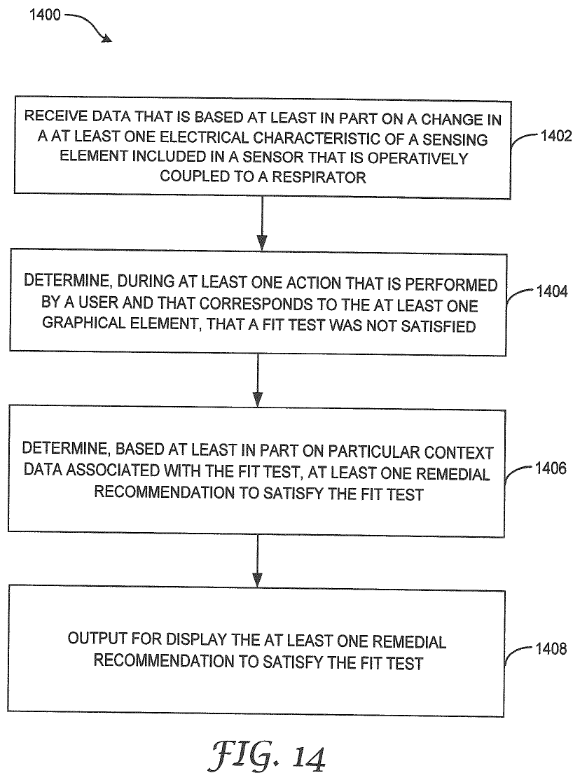

FIG. 14 is a flow diagram illustrating example operations of a respiratory fit-testing system that provides remedial recommendations, in accordance with one or more techniques of this disclosure. For purposes of illustration only, the example operations 1400 are described below within the context of mobile computing device 106. In some examples, mobile computing device 106 may receive data that is based at least in part on a change in the at least one electrical characteristic of a sensing element included in a sensor that is operatively coupled to a respirator (1402). Mobile computing device 106 may determine, during at least one action that is performed by a user and that corresponds to the at least one graphical element, that a fit test was not satisfied (1404). In some examples, the sensor comprises: an electric circuit configured to determine the change in the at least one electrical characteristic of the sensing element. The change in the at least one electrical characteristic may be based at least in part on detection of particulate matter. In some examples, the sensor may comprise a communication component configured to communicate data that is based at least in part on the change in the at least one electrical characteristic of the sensing element. In some examples, mobile computing device 106 may determine, based at least in part on particular context data associated with the fit test, at least one remedial recommendation to satisfy the fit test (1406). In some examples, mobile computing device 106 may output for display the at least one remedial recommendation to satisfy the fit test (1408).

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out all together (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

What is claimed is:

1. A system comprising:
a negative-pressure respirator configured to be worn by a user;
a sensor operatively coupled to the inside of the respirator, the sensor comprising a sensing element configured to detect fluid-soluble particulate matter and generate data based on a change in an electrical property of the sensing element;
a mobile computing device comprising a memory and one or more processors, the memory comprising instructions that, when executed by the one or more processors, cause the one or more processors to:
receive the particulate matter data from the sensor;
determine, based on the particulate matter data from the sensor, whether a fit test of the respirator is satisfied;
output for display, based on the determination, at least one graphical element corresponding to an action to be performed by the user during the fit test.

2. The system of claim 1, further comprising: an aerosol generator device configured to generate and deliver an aerosol comprising particulate matter to an environment proximate to the respirator; wherein the aerosol generator device generates the aerosol based on instructions received from the mobile computing device.

3. The system of claim 1, wherein the mobile computing device is configured to receive a trigger signal from a remote computer via a network to initiate the fit test.

4. The system of claim 3, wherein the remote computer is configured to:
send the trigger signal to the mobile computing device to initiate the fit test;
receive data from the mobile computing device indicating whether the fit test was satisfied; and
store the data in a database for further analysis.

5. The system of claim 3, wherein the remote computer is configured to:
send instructions to the mobile computing device to display specific graphical elements corresponding to actions to be performed by the user during the fit test;
receive data from the mobile computing device indicating the user's performance during the fit test; and
provide feedback to the user based on the received data.

6. The system of claim 1, wherein the mobile computing device is configured to communicate with the aerosol generator device via a wireless communication protocol.

7. The system of claim 1, wherein the sensor is configured to detect a change in impedance of the sensing element as the electrical property.

8. The system of claim 1, wherein the aerosol generator device is configured to adjust the particulate concentration of the aerosol based on instructions from the mobile computing device.

9. The system of claim 1, wherein the mobile computing device is configured to output an alert if the fit test is not satisfied.

10. The system of claim 1, wherein the mobile computing device is configured to store data related to the fit test for later analysis.

11. The system of claim 1, wherein the mobile computing device is configured to communicate with a personal protective equipment management system (PPEMS) to manage fit test data.

12. The system of claim 1, wherein the mobile computing device is configured to provide remedial recommendations if the fit test is not satisfied.

13. The system of claim 1, wherein the mobile computing device is configured to compare the particulate concentration inside the respirator with the particulate concentration outside the respirator.

14. A method for performing a fit test of a respirator, the method comprising:
generating, by an aerosol generator device, an aerosol comprising particulate matter and delivering the aerosol to an environment proximate to the respirator worn by a user;
detecting, by a sensor operatively coupled to the inside of the respirator, fluid-soluble particulate matter within the respirator and generating data based on a change in an electrical property of a sensing element of the sensor;
receiving, by a mobile computing device, the particulate matter data from the sensor;
analyzing, by the mobile computing device, the particulate matter data to determine whether the fit test of the respirator is satisfied;
outputting, by the mobile computing device, at least one graphical element corresponding to an action to be performed by the user during the fit test based on the determination.

15. The method of claim 14, further comprising generating the aerosol by the aerosol generator device based on instructions received from the mobile computing device.

16. The method of claim 14, further comprising receiving, by the mobile computing device, a trigger signal from a remote computer via a network to initiate the fit test.

17. The method of claim 16, further comprising:
sending, by the remote computer, the trigger signal to the mobile computing device to initiate the fit test;
receiving, by the remote computer, data from the mobile computing device indicating whether the fit test was satisfied; and
storing the data in a database for further analysis.

18. The method of claim 16, further comprising:
sending, by the remote computer, instructions to the mobile computing device to display specific graphical elements corresponding to actions to be performed by the user during the fit test;
receiving, by the remote computer, data from the mobile computing device indicating the user's performance during the fit test; and
providing feedback to the user based on the received data.

19. The method of claim 14, further comprising communicating, by the mobile computing device, with the aerosol generator device via a wireless communication protocol.

20. The method of claim 14, further comprising adjusting, by the aerosol generator device, the particulate concentration of the aerosol based on instructions from the mobile computing device.
